(19) United States
(12) Patent Application Publication
(10) Pub. No.: US 2018/0227856 A1
(43) Pub. Date: Aug. 9, 2018

(54) TECHNIQUES AND APPARATUSES FOR PREDICTING TRAFFIC TO CONFIGURE USER EQUIPMENT FEATURES

(71) Applicant: QUALCOMM Incorporated, San Diego, CA (US)

(72) Inventors: Yue YANG, San Diego, CA (US); Aziz Gholmieh, Del Mar, CA (US); Srinivasan Balasubramanian, San Diego, CA (US)

(21) Appl. No.: 15/427,753

(22) Filed: Feb. 8, 2017

(51) Int. Cl. H04W 52/02; H04W 76/04; H04B 17/391

(52) U.S. Cl. CPC H04W 52/0274; H04W 52/0238; H04B 17/3913; H04W 76/048

(57) ABSTRACT

Certain aspects of the present disclosure generally relate to wireless communication. In some aspects, a wireless communication device may predict a traffic pattern, as a predicted traffic pattern, for one or more time intervals of the wireless communication device, wherein the predicted traffic pattern is predicted based at least in part on a traffic type of traffic transmitted or received by the wireless communication device and a connected mode discontinuous reception (CDRx) configuration of the wireless communication device; and selectively configure activation or deactivation of one or more features of the wireless communication device according to the predicted traffic pattern. Numerous other aspects are provided.

### FIELD OF THE DISCLOSURE

Aspects of the present disclosure generally relate to wireless communication, and more particularly to techniques and apparatuses for predicting traffic to configure user equipment features.

### BACKGROUND

Wireless communication systems are widely deployed to provide various telecommunication services, such as telephony, video, data, messaging, and broadcasts. Typical wireless communication systems may employ multiple-access technologies capable of supporting communication with multiple users by sharing available system resources (e.g., bandwidth, transmit power, and/or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency divisional multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, a national, a regional, and even a global level. An example of a telecommunication standard is Long Term Evolution (LTE). LTE is a set of enhancements to the Universal Mobile Telecommunications System (UMTS) mobile standard promulgated by Third Generation Partnership Project (3GPP). LTE is designed to better support mobile broadband Internet access by improving spectral efficiency, lowering costs, improving services, using new spectrum, and integrating with other open standards using OFDMA on the downlink (DL), SC-FDMA on the uplink (UL), and multiple-input multiple-output (MIMO) antenna technology.

### SUMMARY

In some aspects, a method of wireless communication may include predicting a traffic pattern, as a predicted traffic pattern, for one or more time intervals of a user equipment, wherein the predicted traffic pattern is predicted based at least in part on a traffic type of traffic transmitted or received by the user equipment and a connected mode discontinuous reception (CDRx) configuration of the user equipment. The method may include selectively configuring activation or deactivation of one or more features of the user equipment according to the predicted traffic pattern.

In some aspects, a wireless communication device may include a memory and one or more processors operatively coupled to the memory. The one or more processors may be configured to predict a traffic pattern, as a predicted traffic pattern, for one or more time intervals of the wireless communication device, wherein the predicted traffic pattern is predicted based at least in part on a traffic type of traffic transmitted or received by the wireless communication device and a CDRx configuration of the user equipment. The one or more processors may be configured to selectively configure activation or deactivation of one or more features of the wireless communication device according to the predicted traffic pattern.

In some aspects, a non-transitory computer-readable medium may store one or more instructions for wireless communication. The one or more instructions, when executed by one or more processors of a wireless communication device, may cause the one or more processors to predict a traffic pattern, as a predicted traffic pattern, for one or more time intervals of the wireless communication device, wherein the predicted traffic pattern is predicted based at least in part on a traffic type of traffic transmitted or received by the wireless communication device and a CDRx configuration of the wireless communication device. The one or more instructions, when executed by the one or more processors, may cause the one or more processors to selectively configure activation or deactivation of one or more features of the wireless communication device according to the predicted traffic pattern.

In some aspects, an apparatus for wireless communication may include means for predicting a traffic pattern, as a predicted traffic pattern, for one or more time intervals of the apparatus, wherein the predicted traffic pattern is predicted based at least in part on a traffic type of traffic transmitted or received by the apparatus and a CDRx configuration of the apparatus. The apparatus may include means for selectively configuring activation or deactivation of one or more features of the apparatus according to the predicted traffic pattern.

Aspects generally include a method, apparatus, system, computer program product, non-transitory computer-readable medium, user equipment, wireless communication device, and processing system as substantially described herein with reference to and as illustrated by the accompanying drawings.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purpose of illustration and description, and not as a definition of the limits of the claims.

### BRIEF DESCRIPTION OF THE DRAWINGS

So that the manner in which the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example deployment in which multiple wireless networks have overlapping coverage, in accordance with various aspects of the present disclosure.

FIG. 2 is a diagram illustrating an example access network in an LTE network architecture, in accordance with various aspects of the present disclosure.

FIG. 3 is a diagram illustrating an example of a downlink frame structure in LTE, in accordance with various aspects of the present disclosure.

FIG. 4 is a diagram illustrating an example of an uplink frame structure in LTE, in accordance with various aspects of the present disclosure.

FIG. 5 is a diagram illustrating an example of a radio protocol architecture for a user plane and a control plane in LTE, in accordance with various aspects of the present disclosure.

FIG. 6 is a diagram illustrating example components of an evolved Node B and a user equipment in an access network, in accordance with various aspects of the present disclosure.

FIGS. 7A and 7B are diagrams illustrating an example of predicting traffic to configure user equipment features, in accordance with various aspects of the present disclosure.

FIG. 8 is a diagram illustrating an example process performed, for example, by a wireless communication device, in accordance with various aspects of the present disclosure.

FIG. 9 is a diagram illustrating an example process performed, for example, by a wireless communication device, in accordance with various aspects of the present disclosure.

FIG. 10 is a diagram illustrating an example process performed, for example, by a wireless communication device, in accordance with various aspects of the present disclosure.

FIG. 11 is a conceptual data flow diagram illustrating the data flow between different modules/means/components in an example apparatus, in accordance with various aspects of the present disclosure.

FIG. 12 is a diagram illustrating an example of a hardware implementation for an apparatus employing a processing system, in accordance with various aspects of the present disclosure.

### DETAILED DESCRIPTION

The detailed description set forth below, in connection with the appended drawings, is intended as a description of various configurations and is not intended to represent the only configurations in which the concepts described herein may be practiced. The detailed description includes specific details for providing a thorough understanding of the various concepts. However, it will be apparent to those skilled in the art that these concepts may be practiced without these specific details.

The techniques described herein may be used for one or more of various wireless communication networks such as code division multiple access (CDMA) networks, time division multiple access (TDMA) networks, frequency division multiple access (FDMA) networks, orthogonal FDMA (OFDMA) networks, single carrier FDMA (SC-FDMA) networks, or other types of networks. A CDMA network may implement a radio access technology (RAT) such as universal terrestrial radio access (UTRA), CDMA2000, and/or the like. UTRA may include wideband CDMA (WCDMA) and/or other variants of CDMA. CDMA2000 may include Interim Standard (IS)-2000, IS-95 and IS-856 standards. IS-2000 may also be referred to as 1× radio transmission technology (1×RTT), CDMA2000 1×, and/or the like. A TDMA network may implement a RAT such as global system for mobile communications (GSM), enhanced data rates for GSM evolution (EDGE), or GSM/EDGE radio access network (GERAN). An OFDMA network may implement a RAT such as evolved UTRA (E-UTRA), ultra mobile broadband (UMB), Institute of Electrical and Electronics Engineers (IEEE) 802.11 (Wi-Fi), IEEE 802.16 (WiMAX), IEEE 802.20, Flash-OFDM, and/or the like. UTRA and E-UTRA may be part of the universal mobile telecommunication system (UMTS). 3GPP long-term evolution (LTE) and LTE-Advanced (LTE-A) are example releases of UMTS that use E-UTRA, which employs OFDMA on the downlink and SC-FDMA on the uplink. UTRA, E-UTRA, UMTS, LTE, LTE-A and GSM are described in documents from an organization named “3rd Generation Partnership Project” (3GPP). CDMA2000 and UMB are described in documents from an organization named “3rd Generation Partnership Project 2” (3GPP2). The techniques described herein may be used for the wireless networks and RATs mentioned above as well as other wireless networks and RATs.

Additionally, or alternatively, the techniques described herein may be used in connection with New Radio (NR), which may also be referred to as 5G. New Radio is a set of enhancements to the LTE mobile standard promulgated by the 3GPP. NR is designed to better support mobile broadband Internet access by improving spectral efficiency, lowering costs, improving services, making use of new spectrum, and better integrating with other open standards using OFDM with a cyclic prefix (CP) (CP-OFDM) on the downlink (DL), using CP-OFDM and/or SC-FDM (e.g., also known as discrete Fourier transform spread ODFM (DFT-s-OFDM)) on the uplink (UL), as well as supporting beamforming, multiple-input multiple-output (MIMO) antenna technology, and carrier aggregation.

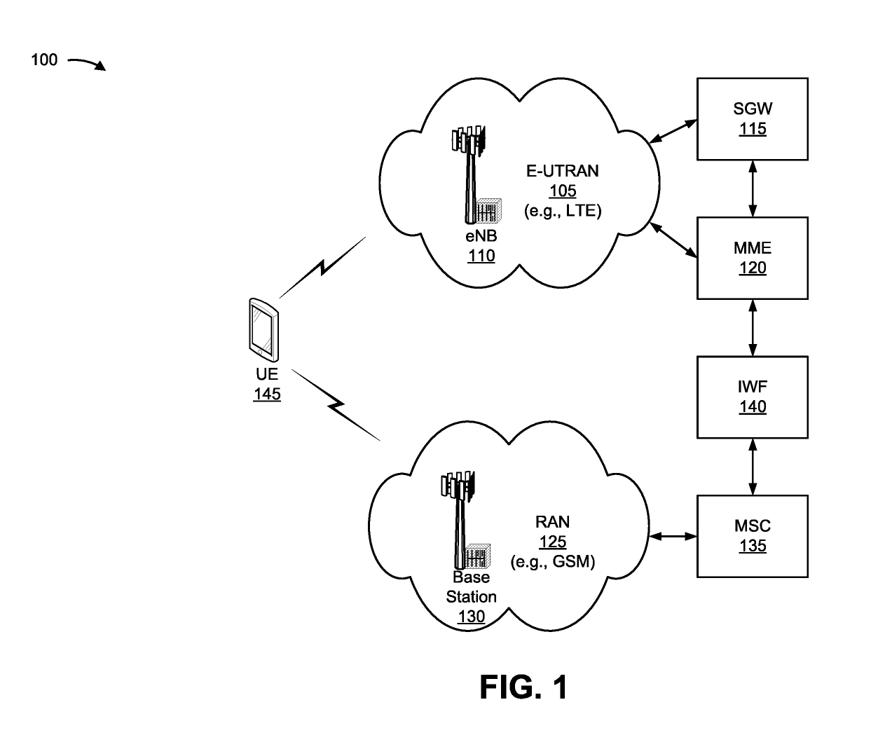

FIG. 1 is a diagram illustrating an example deployment 100 in which multiple wireless networks have overlapping coverage, in accordance with various aspects of the present disclosure. However, wireless networks may not have overlapping coverage in aspects. As shown, example deployment 100 may include an evolved universal terrestrial radio access network (E-UTRAN) 105, which may include one or more evolved Node Bs (eNBs) 110, and which may communicate with other devices or networks via a serving gateway (SGW) 115 and/or a mobility management entity (MME) 120. As further shown, example deployment 100 may include a radio access network (RAN) 125, which may include one or more base stations 130, and which may communicate with other devices or networks via a mobile switching center (MSC) 135 and/or an inter-working function (IWF) 140. As further shown, example deployment 100 may include one or more user equipment (UEs) 145 capable of communicating via E-UTRAN 105 and/or RAN 125.

E-UTRAN 105 may support, for example, LTE or another type of RAT. E-UTRAN 105 may include eNBs 110 and other network entities that can support wireless communication for UEs 145. Each eNB 110 may provide communication coverage for a particular geographic area. The term “cell” may refer to a coverage area of eNB 110 and/or an eNB subsystem serving the coverage area on a specific frequency channel.

SGW 115 may communicate with E-UTRAN 105 and may perform various functions, such as packet routing and forwarding, mobility anchoring, packet buffering, initiation of network-triggered services, and/or the like. MME 120 may communicate with E-UTRAN 105 and SGW 115 and may perform various functions, such as mobility management, bearer management, distribution of paging messages, security control, authentication, gateway selection, and/or the like, for UEs 145 located within a geographic region served by MME 120 of E-UTRAN 105. The network entities in LTE are described in 3GPP TS 36.300, entitled “Evolved Universal Terrestrial Radio Access (E-UTRA) and Evolved Universal Terrestrial Radio Access Network (E-UTRAN); Overall description,” which is publicly available.

RAN 125 may support, for example, GSM or another type of RAT. RAN 125 may include base stations 130 and other network entities that can support wireless communication for UEs 145. MSC 135 may communicate with RAN 125 and may perform various functions, such as voice services, routing for circuit-switched calls, and mobility management for UEs 145 located within a geographic region served by MSC 135 of RAN 125. In some aspects, IWF 140 may facilitate communication between MME 120 and MSC 135 (e.g., when E-UTRAN 105 and RAN 125 use different RATs). Additionally, or alternatively, MME 120 may communicate directly with an MME that interfaces with RAN 125, for example, without IWF 140 (e.g., when E-UTRAN 105 and RAN 125 use a same RAT). In some aspects, E-UTRAN 105 and RAN 125 may use the same frequency and/or the same RAT to communicate with UE 145. In some aspects, E-UTRAN 105 and RAN 125 may use different frequencies and/or RATs to communicate with UEs 145. As used herein, the term base station is not tied to any particular RAT, and may refer to an eNB (e.g., of an LTE network) or another type of base station associated with a different type of RAT.

In general, any number of wireless networks may be deployed in a given geographic area. Each wireless network may support a particular RAT and may operate on one or more frequencies. A RAT may also be referred to as a radio technology, an air interface, and/or the like. A frequency or frequency ranges may also be referred to as a carrier, a frequency channel, and/or the like. Each frequency or frequency range may support a single RAT in a given geographic area in order to avoid interference between wireless networks of different RATs. In some cases, NR or 5G RAT networks may be deployed.

UE 145 may be stationary or mobile and may also be referred to as a mobile station, a terminal, an access terminal, a wireless communication device, a subscriber unit, a station, and/or the like. UE 145 may be a cellular phone, a personal digital assistant (PDA), a wireless modem, a wireless communication device, a handheld device, a laptop computer, a cordless phone, a wireless local loop (WLL) station, and/or the like.

Upon power up, UE 145 may search for wireless networks from which UE 145 can receive communication services. If UE 145 detects more than one wireless network, then a wireless network with the highest priority may be selected to serve UE 145 and may be referred to as the serving network. UE 145 may perform registration with the serving network, if necessary. UE 145 may then operate in a connected mode to actively communicate with the serving network. Alternatively, UE 145 may operate in an idle mode and camp on the serving network if active communication is not required by UE 145.

UE 145 may operate in the idle mode as follows. UE 145 may identify all frequencies/RATs on which it is able to find a “suitable” cell in a normal scenario or an “acceptable” cell in an emergency scenario, where “suitable” and “acceptable” are specified in the LTE standards. UE 145 may then camp on the frequency/RAT with the highest priority among all identified frequencies/RATs. UE 145 may remain camped on this frequency/RAT until either (i) the frequency/RAT is no longer available at a predetermined threshold or (ii) another frequency/RAT with a higher priority reaches this threshold. In some aspects, UE 145 may receive a neighbor list when operating in the idle mode, such as a neighbor list included in a system information block type 5 (SIB 5) provided by an eNB of a RAT on which UE 145 is camped. Additionally, or alternatively, UE 145 may generate a neighbor list. A neighbor list may include information identifying one or more frequencies, at which one or more RATs may be accessed, priority information associated with the one or more RATs, and/or the like.

In some examples, access to the air interface may be scheduled, wherein a scheduling entity (e.g., a base station) allocates resources for communication among some or all devices and equipment within the scheduling entity's service area or cell. Within the present disclosure, as discussed further below, the scheduling entity may be responsible for scheduling, assigning, reconfiguring, and releasing resources for one or more subordinate entities. That is, for scheduled communication, subordinate entities utilize resources allocated by the scheduling entity.

Base stations are not the only entities that may function as a scheduling entity. That is, in some examples, a UE may function as a scheduling entity, scheduling resources for one or more subordinate entities (e.g., one or more other UEs). In this example, the UE is functioning as a scheduling entity, and other UEs utilize resources scheduled by the UE for wireless communication. A UE may function as a scheduling entity in a peer-to-peer (P2P) network, and/or in a mesh network. In a mesh network example, UEs may optionally communicate directly with one another in addition to communicating with the scheduling entity.

Thus, in a wireless communication network with a scheduled access to time-frequency resources and having a cellular configuration, a P2P configuration, and a mesh configuration, a scheduling entity and one or more subordinate entities may communicate utilizing the scheduled resources.

The number and arrangement of devices and networks shown in FIG. 1 are provided as an example. In practice, there may be additional devices and/or networks, fewer devices and/or networks, different devices and/or networks, or differently arranged devices and/or networks than those shown in FIG. 1. Furthermore, two or more devices shown in FIG. 1 may be implemented within a single device, or a single device shown in FIG. 1 may be implemented as multiple, distributed devices. Additionally, or alternatively, a set of devices (e.g., one or more devices) shown in FIG. 1 may perform one or more functions described as being performed by another set of devices shown in FIG. 1.

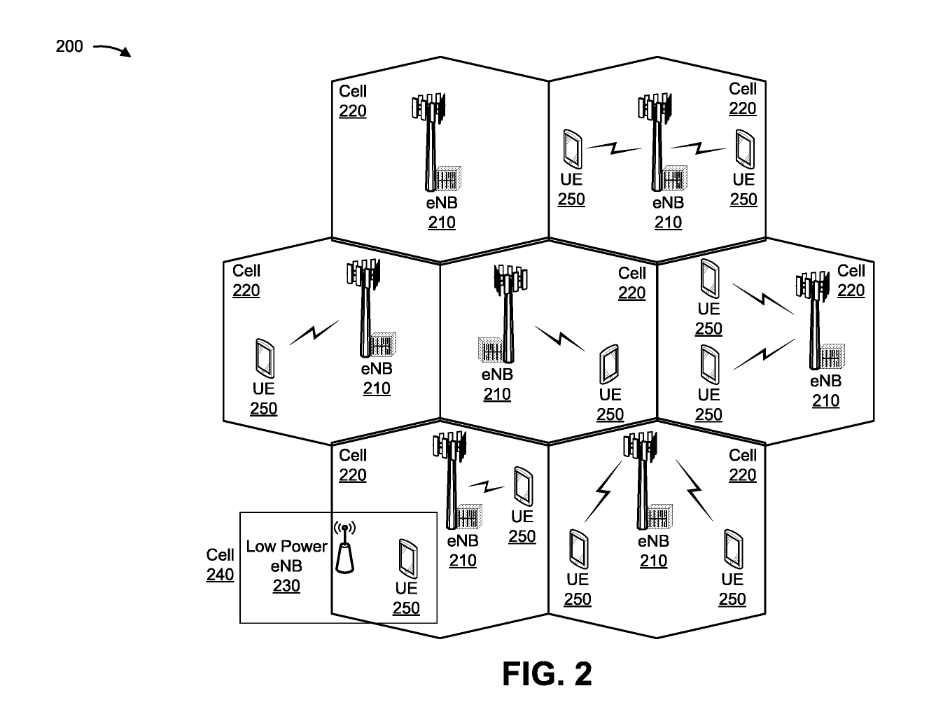

FIG. 2 is a diagram illustrating an example access network 200 in an LTE network architecture, in accordance with various aspects of the present disclosure. As shown, access network 200 may include one or more eNBs 210 (sometimes referred to as “base stations” herein) that serve a corresponding set of cellular regions (cells) 220, one or more low power eNBs 230 that serve a corresponding set of cells 240, and a set of UEs 250.

Each eNB 210 may be assigned to a respective cell 220 and may be configured to provide an access point to a RAN. For example, eNB 110, 210 may provide an access point for UE 145, 250 to E-UTRAN 105 (e.g., eNB 210 may correspond to eNB 110, shown in FIG. 1) or may provide an access point for UE 145, 250 to RAN 125 (e.g., eNB 210 may correspond to base station 130, shown in FIG. 1). In some cases, the terms base station and eNB may be used interchangeably, and a base station, as used herein, is not tied to any particular RAT. UE 145, 250 may correspond to UE 145, shown in FIG. 1. FIG. 2 does not illustrate a centralized controller for example access network 200, but access network 200 may use a centralized controller in some aspects. The eNBs 210 may perform radio related functions including radio bearer control, admission control, mobility control, scheduling, security, and network connectivity (e.g., to SGW 115).

As shown in FIG. 2, one or more low power eNBs 230 may serve respective cells 240, which may overlap with one or more cells 220 served by eNBs 210. The eNBs 230 may correspond to eNB 110 associated with E-UTRAN 105 and/or base station 130 associated with RAN 125, shown in FIG. 1. A low power eNB 230 may be referred to as a remote radio head (RRH). The low power eNB 230 may include a femto cell eNB (e.g., home eNB (HeNB)), a pico cell eNB, a micro cell eNB, and/or the like.

A modulation and multiple access scheme employed by access network 200 may vary depending on the particular telecommunications standard being deployed. In LTE applications, OFDM is used on the downlink (DL) and SC-FDMA is used on the uplink (UL) to support both frequency division duplexing (FDD) and time division duplexing (TDD). The various concepts presented herein are well suited for LTE applications. However, these concepts may be readily extended to other telecommunication standards employing other modulation and multiple access techniques. By way of example, these concepts may be extended to Evolution-Data Optimized (EV-DO) or Ultra Mobile Broadband (UMB). EV-DO and UMB are air interface standards promulgated by the 3rd Generation Partnership Project 2 (3GPP2) as part of the CDMA2000 family of standards and employs CDMA to provide broadband Internet access to mobile stations. As another example, these concepts may also be extended to UTRA employing WCDMA and other variants of CDMA (e.g., such as TD-SCDMA, GSM employing TDMA, E-UTRA, and/or the like), UMB, IEEE 802.11 (Wi-Fi), IEEE 802.16 (WiMAX), IEEE 802.20, Flash-OFDM employing OFDMA, and/or the like. UTRA, E-UTRA, UMTS, LTE and GSM are described in documents from the 3GPP organization. CDMA2000 and UMB are described in documents from the 3GPP2 organization. The actual wireless communication standard and the multiple access technology employed will depend on the specific application and the overall design constraints imposed on the system.

The eNBs 210 may have multiple antennas supporting MIMO technology. The use of MIMO technology enables eNBs 210 to exploit the spatial domain to support spatial multiplexing, beamforming, and transmit diversity. Spatial multiplexing may be used to transmit different streams of data simultaneously on the same frequency. The data streams may be transmitted to a single UE 145, 250 to increase the data rate or to multiple UEs 250 to increase the overall system capacity. This may be achieved by spatially precoding each data stream (e.g., applying a scaling of an amplitude and a phase) and then transmitting each spatially precoded stream through multiple transmit antennas on the DL. The spatially precoded data streams arrive at the UE(s) 250 with different spatial signatures, which enables each of the UE(s) 250 to recover the one or more data streams destined for that UE 145, 250. On the UL, each UE 145, 250 transmits a spatially precoded data stream, which enables eNBs 210 to identify the source of each spatially precoded data stream.

Spatial multiplexing is generally used when channel conditions are good. When channel conditions are less favorable, beamforming may be used to focus the transmission energy in one or more directions. This may be achieved by spatially precoding the data for transmission through multiple antennas. To achieve good coverage at the edges of the cell, a single stream beamforming transmission may be used in combination with transmit diversity.

In the detailed description that follows, various aspects of an access network will be described with reference to a MIMO system supporting OFDM on the DL. OFDM is a spread-spectrum technique that modulates data over a number of subcarriers within an OFDM symbol. The subcarriers are spaced apart at precise frequencies. The spacing provides “orthogonality” that enables a receiver to recover the data from the subcarriers. In the time domain, a guard interval (e.g., cyclic prefix) may be added to each OFDM symbol to combat inter-OFDM-symbol interference. The UL may use SC-FDMA in the form of a DFT-spread OFDM signal to compensate for high peak-to-average power ratio (PAPR).

The number and arrangement of devices and cells shown in FIG. 2 are provided as an example. In practice, there may be additional devices and/or cells, fewer devices and/or cells, different devices and/or cells, or differently arranged devices and/or cells than those shown in FIG. 2. Furthermore, two or more devices shown in FIG. 2 may be implemented within a single device, or a single device shown in FIG. 2 may be implemented as multiple, distributed devices. Additionally, or alternatively, a set of devices (e.g., one or more devices) shown in FIG. 2 may perform one or more functions described as being performed by another set of devices shown in FIG. 2.

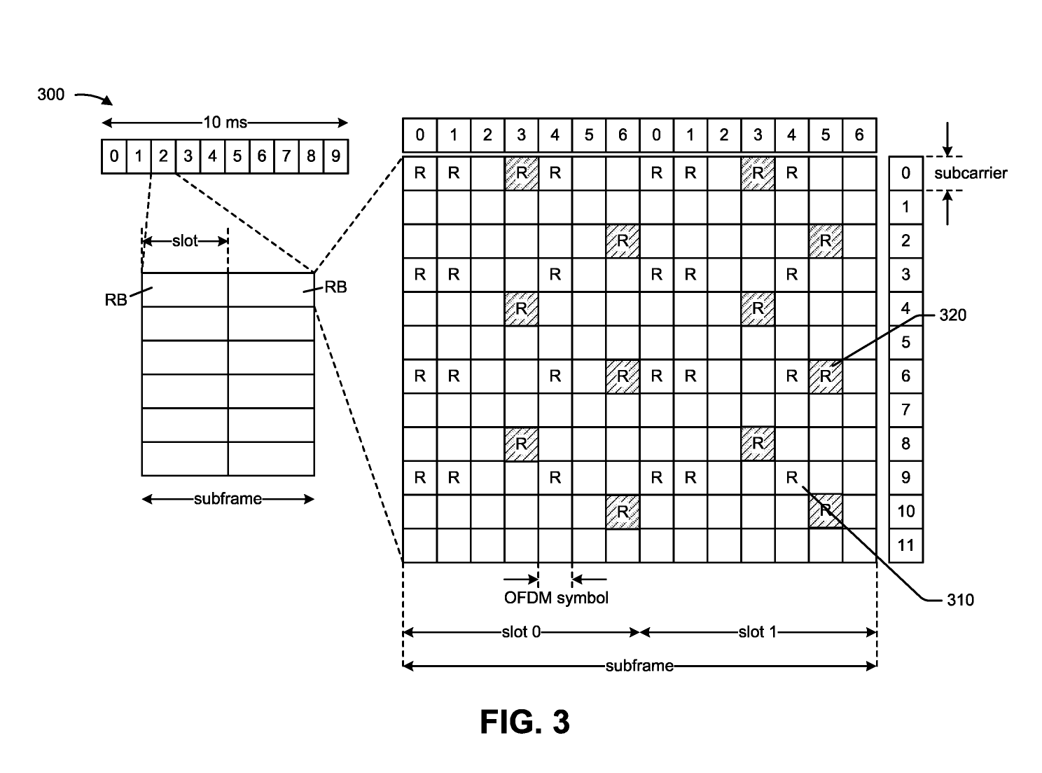

FIG. 3 is a diagram illustrating an example 300 of a downlink (DL) frame structure in LTE, in accordance with various aspects of the present disclosure. A frame (e.g., of 10 ms) may be divided into 10 equally sized sub-frames with indices of 0 through 9. Each sub-frame may include two consecutive time slots. A resource grid may be used to represent two time slots, each time slot including a resource block (RB). The resource grid is divided into multiple resource elements. In LTE, a resource block includes 12 consecutive subcarriers in the frequency domain and, for a normal cyclic prefix in each OFDM symbol, 7 consecutive OFDM symbols in the time domain, or 84 resource elements. For an extended cyclic prefix, a resource block includes 6 consecutive OFDM symbols in the time domain and has 72 resource elements. Some of the resource elements, as indicated as R 310 and R 320, include DL reference signals (DL-RS). The DL-RS include Cell-specific RS (CRS) (also sometimes called common RS) 310 and UE-specific RS (UE-RS) 320. UE-RS 320 are transmitted only on the resource blocks upon which the corresponding physical DL shared channel (PDSCH) is mapped. The number of bits carried by each resource element depends on the modulation scheme. Thus, the more resource blocks that a UE receives and the higher the modulation scheme, the higher the data rate for the UE.

In LTE, an eNB may send a primary synchronization signal (PSS) and a secondary synchronization signal (SSS) for each cell in the eNB. The primary and secondary synchronization signals may be sent in symbol periods 6 and 5, respectively, in each of subframes 0 and 5 of each radio frame with the normal cyclic prefix (CP). The synchronization signals may be used by UEs for cell detection and acquisition. The eNB may send a Physical Broadcast Channel (PBCH) in symbol periods 0 to 3 in slot 1 of subframe 0. The PBCH may carry certain system information.

The eNB may send a Physical Control Format Indicator Channel (PCFICH) in the first symbol period of each subframe. The PCFICH may convey the number of symbol periods (M) used for control channels, where M may be equal to 1, 2 or 3 and may change from subframe to subframe. M may also be equal to 4 for a small system bandwidth, e.g., with less than 10 resource blocks. The eNB may send a Physical hybrid automatic repeat request (HARQ) Indicator Channel (PHICH) and a Physical Downlink Control Channel (PDCCH) in the first M symbol periods of each subframe. The PHICH may carry information to support HARQ. The PDCCH may carry information on resource allocation for UEs and control information for downlink channels. The eNB may send a Physical Downlink Shared Channel (PDSCH) in the remaining symbol periods of each subframe. The PDSCH may carry data for UEs scheduled for data transmission on the downlink.

The eNB may send the PSS, SSS, and PBCH in the center 1.08 MHz of the system bandwidth used by the eNB. The eNB may send the PCFICH and PHICH across the entire system bandwidth in each symbol period in which these channels are sent. The eNB may send the PDCCH to groups of UEs in certain portions of the system bandwidth. The eNB may send the PDSCH to specific UEs in specific portions of the system bandwidth. The eNB may send the PSS, SSS, PBCH, PCFICH, and PHICH in a broadcast manner to all UEs, may send the PDCCH in a unicast manner to specific UEs, and may also send the PDSCH in a unicast manner to specific UEs.

A number of resource elements may be available in each symbol period. Each resource element (RE) may cover one subcarrier in one symbol period and may be used to send one modulation symbol, which may be a real or complex value. Resource elements not used for a reference signal in each symbol period may be arranged into resource element groups (REGs). Each REG may include four resource elements in one symbol period. The PCFICH may occupy four REGs, which may be spaced approximately equally across frequency, in symbol period 0. The PHICH may occupy three REGs, which may be spread across frequency, in one or more configurable symbol periods. For example, the three REGs for the PHICH may all belong in symbol period 0 or may be spread in symbol periods 0, 1, and 2. The PDCCH may occupy 9, 18, 36, or 72 REGs, which may be selected from the available REGs, in the first M symbol periods, for example. Only certain combinations of REGs may be allowed for the PDCCH.

A UE may know the specific REGs used for the PHICH and the PCFICH. The UE may search different combinations of REGs for the PDCCH. The number of combinations to search is typically less than the number of allowed combinations for the PDCCH. An eNB may send the PDCCH to the UE in any of the combinations that the UE will search. In some systems (e.g., such NR or 5G systems), an eNB may transmit these or other signals in these locations or in different locations of the subframe. Furthermore, while aspects of the examples described herein may be associated with LTE technologies, aspects of the present disclosure may be applicable with other wireless communication systems, such as NR or 5G technologies.

As indicated above, FIG. 3 is provided as an example. Other examples are possible and may differ from what was described above in connection with FIG. 3.

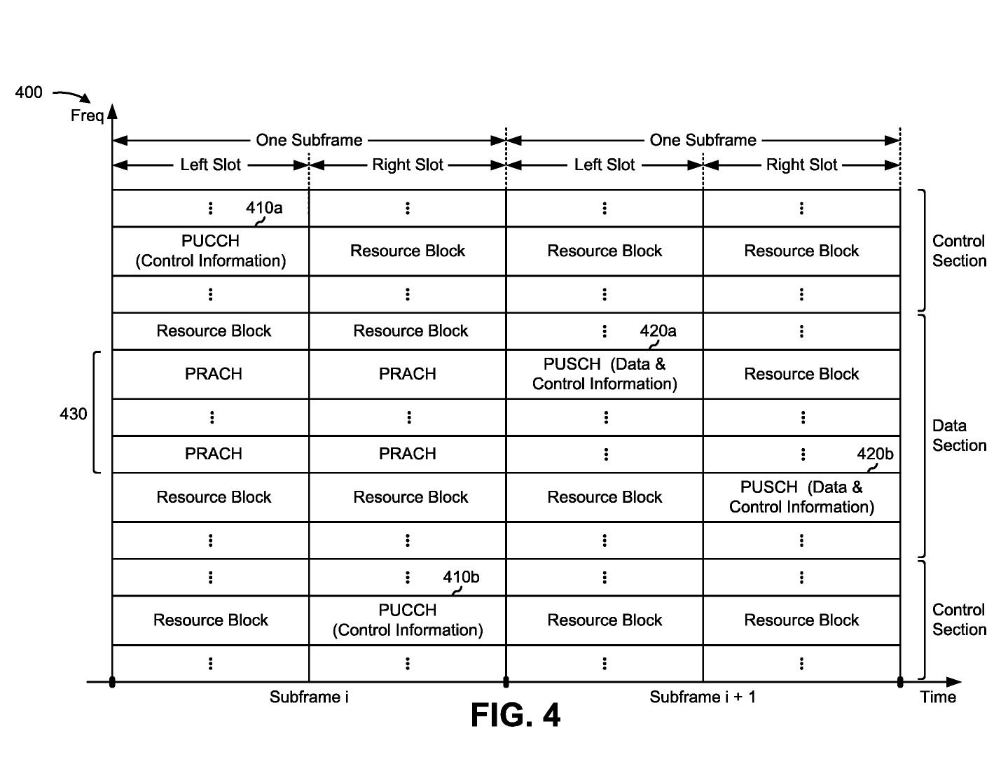

FIG. 4 is a diagram illustrating an example 400 of an uplink (UL) frame structure in LTE, in accordance with various aspects of the present disclosure. The available resource blocks for the UL may be partitioned into a data section and a control section. The control section may be formed at the two edges of the system bandwidth and may have a configurable size. The resource blocks in the control section may be assigned to UEs for transmission of control information. The data section may include all resource blocks not included in the control section. The UL frame structure results in the data section including contiguous subcarriers, which may allow a single UE to be assigned all of the contiguous subcarriers in the data section.

A UE may be assigned resource blocks 410a, 410b in the control section to transmit control information to an eNB. The UE may also be assigned resource blocks 420a, 420b in the data section to transmit data to the eNB. The UE may transmit control information in a physical UL control channel (PUCCH) on the assigned resource blocks in the control section. The UE may transmit only data or both data and control information in a physical UL shared channel (PUSCH) on the assigned resource blocks in the data section. A UL transmission may span both slots of a subframe and may hop across frequencies.

A set of resource blocks may be used to perform initial system access and achieve UL synchronization in a physical random access channel (PRACH) 430. The PRACH 430 carries a random sequence and cannot carry any UL data/signaling. Each random access preamble occupies a bandwidth corresponding to six consecutive resource blocks. The starting frequency is specified by the network. That is, the transmission of the random access preamble is restricted to certain time and frequency resources. There is no frequency hopping for the PRACH. The PRACH attempt is carried in a single subframe (e.g., of 1 ms) or in a sequence of few contiguous subframes and a UE can make only a single PRACH attempt per frame (e.g., of 10 ms).

While some techniques are described herein in connection with frames, subframes, slots, and/or the like, these techniques may equally apply to other types of wireless communication structures, which may be referred to using terms other than “frame,” “subframe,” “slot,” and/or the like in 5G NR. In some aspects, a wireless communication structure may refer to a periodic time-bounded communication unit defined by a wireless communication standard and/or protocol.

As indicated above, FIG. 4 is provided as an example. Other examples are possible and may differ from what was described above in connection with FIG. 4.

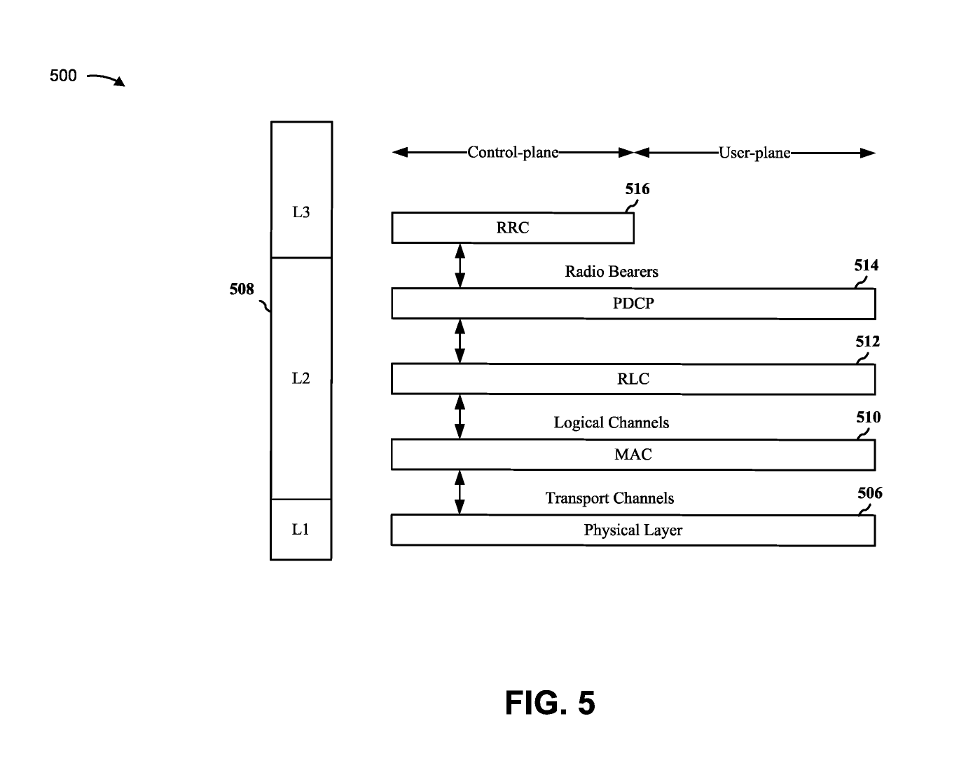

FIG. 5 is a diagram illustrating an example 500 of a radio protocol architecture for a user plane and a control plane in LTE, in accordance with various aspects of the present disclosure. The radio protocol architecture for the UE and the eNB is shown with three layers: Layer 1, Layer 2, and Layer 3. Layer 1 (L1 layer) is the lowest layer and implements various physical layer signal processing functions. The L1 layer will be referred to herein as the physical layer 510. Layer 2 (L2 layer) 520 is above the physical layer 510 and is responsible for the link between the UE and eNB over the physical layer 510.

In the user plane, the L2 layer 520 includes, for example, a media access control (MAC) sublayer 530, a radio link control (RLC) sublayer 540, and a packet data convergence protocol (PDCP) sublayer 550, which are terminated at the eNB on the network side. Although not shown, the UE may have several upper layers above the L2 layer 520 including a network layer (e.g., IP layer) that is terminated at a packet data network (PDN) gateway on the network side, and an application layer that is terminated at the other end of the connection (e.g., a far end UE, a server, and/or the like).

The PDCP sublayer 550 provides retransmission of lost data in handover. The PDCP sublayer 550 also provides header compression for upper layer data packets to reduce radio transmission overhead, security by ciphering the data packets, and handover support for UEs between eNBs. The RLC sublayer 540 provides segmentation and reassembly of upper layer data packets, retransmission of lost data packets, and reordering of data packets to compensate for out-of-order reception due to hybrid automatic repeat request (HARQ). The MAC sublayer 530 provides multiplexing between logical and transport channels. The MAC sublayer 530 is also responsible for allocating the various radio resources (e.g., resource blocks) in one cell among the UEs. The MAC sublayer 530 is also responsible for HARQ operations.

In the control plane, the radio protocol architecture for the UE and eNB is substantially the same for the physical layer 510 and the L2 layer 520 with the exception that there is no header compression function for the control plane. The control plane also includes a radio resource control (RRC) sublayer 560 in Layer 3 (L3 layer). The RRC sublayer 560 is responsible for obtaining radio resources (i.e., radio bearers) and for configuring the lower layers using RRC signaling between the eNB and the UE.

As indicated above, FIG. 5 is provided as an example. Other examples are possible and may differ from what was described above in connection with FIG. 5.

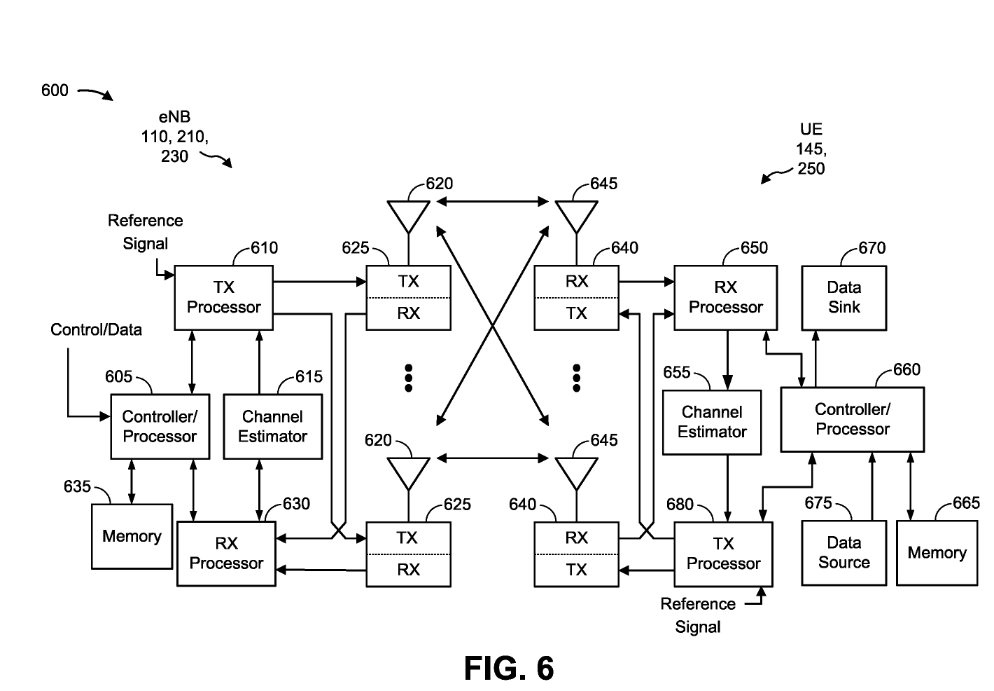

FIG. 6 is a diagram illustrating example components 600 of eNB 110, 210, 230 and UE 145, 250 in an access network, in accordance with various aspects of the present disclosure. As shown in FIG. 6, eNB 110, 210, 230 may include a controller/processor 605, a TX processor 610, a channel estimator 615, an antenna 620, a transmitter 625TX, a receiver 625RX, an RX processor 630, and a memory 635. As further shown in FIG. 6, UE 145, 250 may include a receiver RX, for example, of a transceiver TX/RX 640, a transmitter TX, for example, of a transceiver TX/RX 640, an antenna 645, an RX processor 650, a channel estimator 655, a controller/processor 660, a memory 665, a data sink 670, a data source 675, and a TX processor 680.

In the DL, upper layer packets from the core network are provided to controller/processor 605. The controller/processor 605 implements the functionality of the L2 layer. In the DL, the controller/processor 605 provides header compression, ciphering, packet segmentation and reordering, multiplexing between logical and transport channels, and radio resource allocations to the UE 145, 250 based, at least in part, on various priority metrics. The controller/processor 605 is also responsible for HARQ operations, retransmission of lost packets, and signaling to the UE 145, 250.

The TX processor 610 implements various signal processing functions for the L1 layer (e.g., physical layer). The signal processing functions includes coding and interleaving to facilitate forward error correction (FEC) at the UE 145, 250 and mapping to signal constellations based, at least in part, on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols are then split into parallel streams. Each stream is then mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 615 may be used to determine the coding and modulation scheme, as well as for spatial processing. The channel estimate may be derived from a reference signal and/or channel condition feedback transmitted by the UE 145, 250. Each spatial stream is then provided to a different antenna 620 via a separate transmitter TX, for example, of transceiver TX/RX 625. Each such transmitter TX modulates an RF carrier with a respective spatial stream for transmission.

At the UE 145, 250, each receiver RX, for example, of a transceiver TX/RX 640 receives a signal through its respective antenna 645. Each such receiver RX recovers information modulated onto an RF carrier and provides the information to the receiver (RX) processor 650. The RX processor 650 implements various signal processing functions of the L1 layer. The RX processor 650 performs spatial processing on the information to recover any spatial streams destined for the UE 145, 250. If multiple spatial streams are destined for the UE 145, 250, the spatial streams may be combined by the RX processor 650 into a single OFDM symbol stream. The RX processor 650 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the eNB 110, 210, 230. These soft decisions may be based, at least in part, on channel estimates computed by the channel estimator 655. The soft decisions are then decoded and deinterleaved to recover the data and control signals that were originally transmitted by the eNB 110, 210, 230 on the physical channel. The data and control signals are then provided to the controller/processor 660.

The controller/processor 660 implements the L2 layer. The controller/processor 660 can be associated with a memory 665 that stores program codes and data. The memory 665 may include a non-transitory computer-readable medium. In the UL, the controller/processor 660 provides demultiplexing between transport and logical channels, packet reassembly, deciphering, header decompression, control signal processing to recover upper layer packets from the core network. The upper layer packets are then provided to a data sink 670, which represents all the protocol layers above the L2 layer. Various control signals may also be provided to the data sink 670 for L3 processing. The controller/processor 660 is also responsible for error detection using an acknowledgement (ACK) and/or negative acknowledgement (NACK) protocol to support HARQ operations.

In the UL, a data source 675 is used to provide upper layer packets to the controller/processor 660. The data source 675 represents all protocol layers above the L2 layer. Similar to the functionality described in connection with the DL transmission by the eNB 110, 210, 230, the controller/processor 660 implements the L2 layer for the user plane and the control plane by providing header compression, ciphering, packet segmentation and reordering, and multiplexing between logical and transport channels based, at least in part, on radio resource allocations by the eNB 110, 210, 230. The controller/processor 660 is also responsible for HARQ operations, retransmission of lost packets, and signaling to the eNB 110, 210, 230.

Channel estimates derived by a channel estimator 655 from a reference signal or feedback transmitted by the eNB 110, 210, 230 may be used by the TX processor 680 to select the appropriate coding and modulation schemes, and to facilitate spatial processing. The spatial streams generated by the TX processor 680 are provided to different antenna 645 via separate transmitters TX, for example, of transceivers TX/RX 640. Each transmitter TX, for example, of transceiver TX/RX 640 modulates an RF carrier with a respective spatial stream for transmission.

The UL transmission is processed at the eNB 110, 210, 230 in a manner similar to that described in connection with the receiver function at the UE 145, 250. Each receiver RX, for example, of transceiver TX/RX 625 receives a signal through its respective antenna 620. Each receiver RX, for example, of transceiver TX/RX 625 recovers information modulated onto an RF carrier and provides the information to a RX processor 630. The RX processor 630 may implement the L1 layer.

The controller/processor 605 implements the L2 layer. The controller/processor 605 can be associated with a memory 635 that stores program code and data. The memory 635 may be referred to as a computer-readable medium. In the UL, the control/processor 605 provides demultiplexing between transport and logical channels, packet reassembly, deciphering, header decompression, control signal processing to recover upper layer packets from the UE 145, 250. Upper layer packets from the controller/processor 605 may be provided to the core network. The controller/processor 605 is also responsible for error detection using an ACK and/or NACK protocol to support HARQ operations.

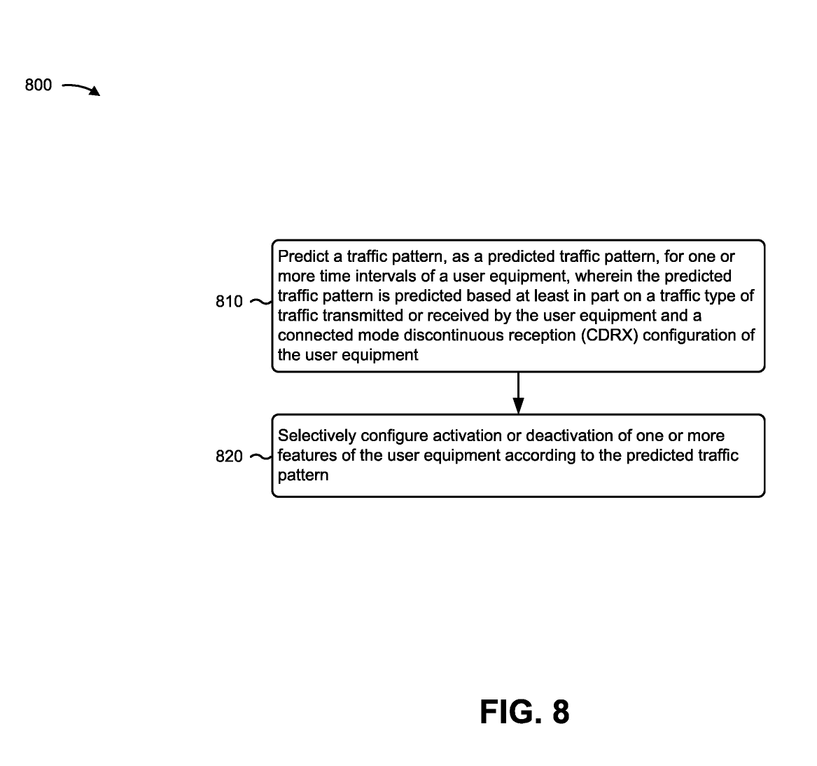

One or more components of UE 145, 250 may be configured to perform prediction of traffic to configure user equipment features, as described in more detail elsewhere herein. For example, the controller/processor 660 and/or other processors and modules of UE 145, 250 may perform or direct operations of, for example, example process 800 of FIG. 8 and/or other processes as described herein. In some aspects, one or more of the components shown in FIG. 6 may be employed to perform example process 800 and/or other processes for the techniques described herein.

The number and arrangement of components shown in FIG. 6 are provided as an example. In practice, there may be additional components, fewer components, different components, or differently arranged components than those shown in FIG. 6. Furthermore, two or more components shown in FIG. 6 may be implemented within a single component, or a single component shown in FIG. 6 may be implemented as multiple, distributed components. Additionally, or alternatively, a set of components (e.g., one or more components) shown in FIG. 6 may perform one or more functions described as being performed by another set of components shown in FIG. 6.

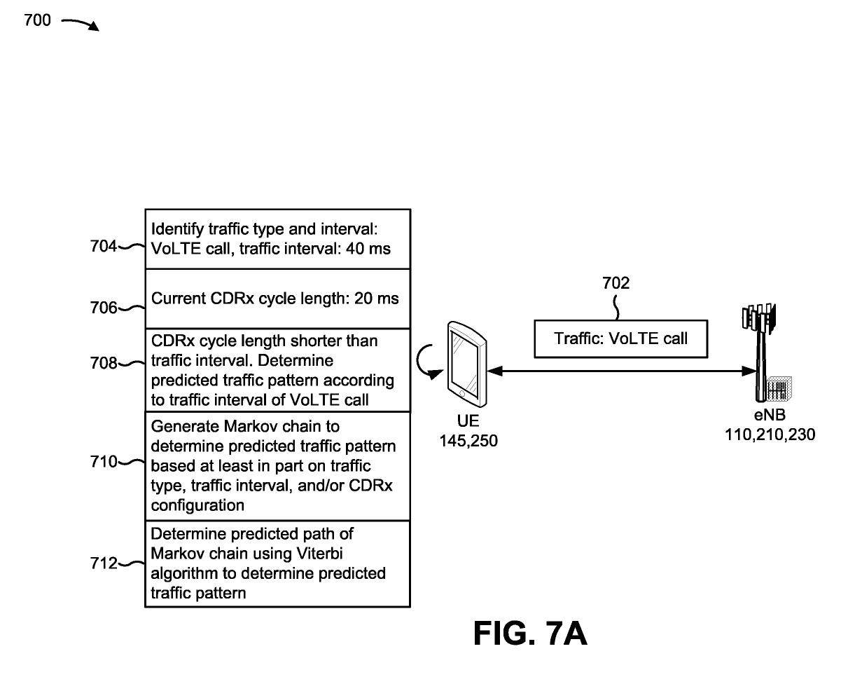

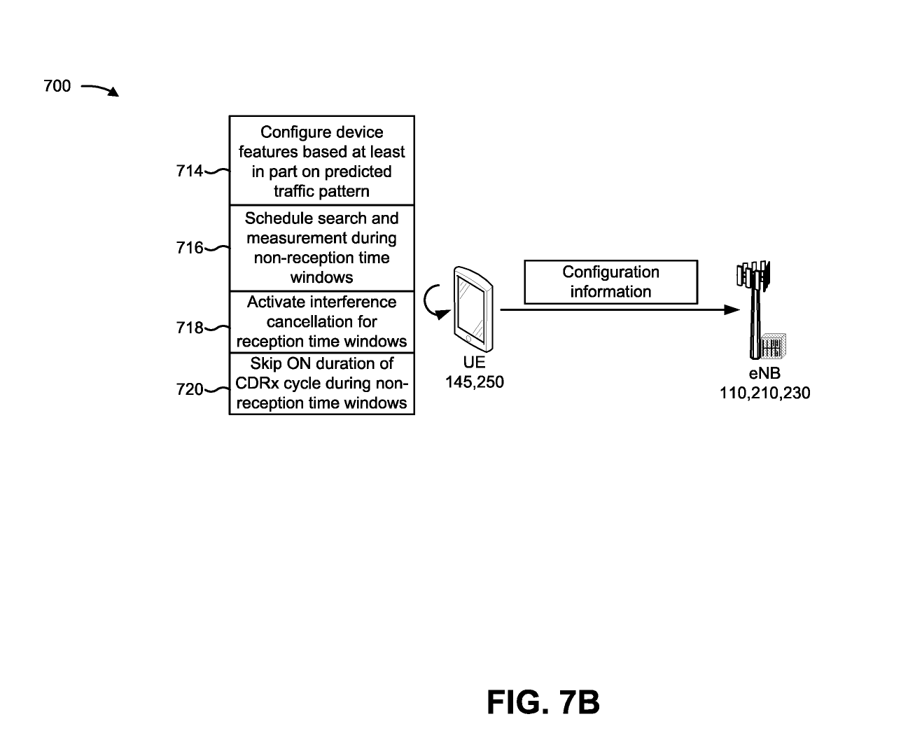

FIGS. 7A and 7B are diagrams illustrating examples 700 of predicting traffic to configure user equipment features, in accordance with various aspects of the present disclosure.

An eNB 110, 210, 230 may schedule traffic to be provided to or transmitted by a UE 145, 250 in particular time windows, such as transmission time intervals (TTIs), RBs, subframes, slots, and/or the like. The eNB 110, 210, 230 may provide scheduling information identifying the particular time windows to the UE 145, 250. This scheduling information may relate to one or more future time windows, but may not identify traffic to be transmitted or received past a certain length of time (e.g., after a next subframe, after a next frame, etc.). Therefore, the UE 145, 250 may not know which time windows, past the certain length of time, will include network traffic.

The UE 145, 250 may implement features to improve performance of the UE 145, 250. These features may include, for example, interference cancellation, a gapless search feature, a gapless measurement feature, a power saving feature (e.g., discontinuous reception (DRx), Connected Mode DRx (CDRx), a sleep mode, etc.), and/or the like. In some cases, a feature may perform better in particular traffic conditions. For example, more downlink traffic may lead to more successful interference cancellation. Additionally, or alternatively, a gapless search and/or measurement feature may be more effective when multiple searches and/or measurements can be scheduled in a particular time window that does not include downlink traffic, because redundant wakeup and warmup actions of the UE 145, 250 can be avoided. Additionally, or alternatively, the UE 145, 250 may skip one or more ON durations of a CDRx cycle, or extend a sleep duration of the CDRx cycle, based at least in part on information indicating that a particular time period is not likely to include downlink traffic. This, in turn, may conserve battery power and processor resources of the UE 145, 250.

In some aspects, traffic provided to or transmitted by the UE 145, 250 may be associated with a traffic type. For example, the traffic type may include a Voice over LTE (VoLTE) traffic type, a Voice over IP (VoIP) traffic type, a video streaming traffic type, a web browsing traffic type, a File Transfer Protocol (FTP) download traffic type, and/or the like. In some aspects, the traffic type may be defined according to an application receiving or generating the traffic and/or a protocol associated with the traffic. Different traffic types may be associated with different patterns of transmission and/or reception, as described in more detail below. For example, a particular traffic type may be associated with uplink or downlink bursts at particular time windows, may be associated with particular time windows of non-transmission or non-reception of traffic, and/or the like.

Methods and apparatuses, described herein, enable a UE 145, 250 to determine a predicted traffic pattern based at least in part on a traffic type of traffic transmitted or received by the UE 145, 250 and a CDRx configuration (e.g., a CDRx cycle length) of the UE 145, 250. The UE 145, 250 may selectively configure activation or deactivation of one or more features of the UE 145, 250 (e.g., interference cancellation, a gapless search and/or measurement feature, an extended sleep or ON duration skipping feature, etc.) based at least in part on the predicted traffic pattern. A traffic pattern may identify predicted or observed occurrences of uplink or downlink traffic in temporal relation to each other. In some aspects, the UE 145, 250 may determine the predicted traffic pattern based at least in part on device information associated with the UE 145, 250, such as motion information, a CQI report, display information, a relationship between uplink traffic and subsequent reception of downlink traffic, and/or the like. By configuring the one or more features based at least in part on the predicted traffic pattern, the UE 145, 250 conserves processor resources, improves uplink and/or downlink performance, and improves network performance.

As shown in FIG. 7A, and by reference number 702, an eNB 110, 210, 230 may provide traffic to and/or receive traffic from a UE 145, 250. Here, the traffic includes a VoLTE call. As further shown, the traffic may be associated with a plurality of time windows, including one or more scheduled time windows and one or more unscheduled time windows. For example, the eNB 110, 210, 230 may schedule uplink traffic of the VoLTE call from the UE 145, 250 and downlink traffic of the VoLTE call to the UE 145, 250 within the scheduled time windows, and may not schedule traffic during the unscheduled time windows. Notably, while implementations described herein are sometimes described in connection with time windows that correspond to wireless communication structures (e.g., frames, subframes, slots, RBs, and/or the like), the time windows described herein are not limited to those corresponding to wireless communication structures. For example, a time window, as described herein, may include any length of time that does or does not conform to a wireless communication structure.

As shown by reference number 704, the UE 145, 250 may identify a traffic type and a traffic interval for the plurality of time windows. As further shown, the UE 145, 250 may identify the traffic type as a VoLTE traffic type (e.g., due to the traffic being associated with a VoLTE call). As further shown, the UE 145, 250 may identify a traffic interval associated with the VoLTE traffic type. For example, a traffic type may be associated with a corresponding traffic interval. The traffic interval may identify time windows corresponding to uplink traffic, downlink traffic, non-transmission, and/or non-reception of traffic of the traffic type.

As shown in FIG. 7A, the UE 145, 250 identifies a traffic interval of 40 ms. For example, in some aspects, the UE 145, 250, when involved in a VoLTE call, may be configured to receive and/or provide a data packet or burst every 40 ms. In such a case, the 40 ms spacing of the data packets or bursts may be useful for determining a predicted traffic pattern of the UE 145, 250, as described in more detail below. In some aspects, the VoLTE traffic type may be associated with a different traffic interval, such as 20 ms, and/or the like.

In some aspects, the traffic may be associated with a different traffic type. For example, the traffic may be associated with a video streaming traffic type. In such a case, the UE 145, 250 may identify a traffic interval that includes a first data reception at a first time and one or more second data receptions after the first data reception. For example, the first data reception may include a larger downlink data burst to buffer a streaming video, and the one or more second data receptions may include smaller data downlink data bursts (e.g., smaller than the larger downlink data burst) to maintain playback of the streaming video.

Additionally, or alternatively, the traffic may be associated with a web browsing traffic type. In such a case, the UE 145, 250 may identify a traffic interval that includes an uplink transmission for a handshake procedure with regard to a source of the web browsing traffic (e.g., a web server and/or the like), followed by a non-scheduled time interval, followed by a downlink reception of the web browsing traffic.

Additionally, or alternatively, the traffic may be associated with an FTP downloading type. In such a case, the UE 145, 250 may identify one or more bursts of downlink traffic based at least in part on the TCP protocol. For example, the UE 145, 250 may identify times at which traffic is likely to be received and/or transmitted based at least in part on handshakes, messages, and/or data transmission times prescribed by the TCP protocol. Notably, the above traffic types may or may not be associated with a regular traffic interval. For example, the traffic interval may identify lengths and/or spacing of non-regular time windows corresponding to uplink traffic, downlink traffic, non-transmission of traffic, and/or non-reception of traffic.

As shown by reference number 706, the UE 145, 250 may identify a CDRx cycle length of the UE 145, 250. CDRx is a process by which the UE 145, 250 may perform intermittent monitoring of the PDCCH in order to conserve battery power. For example, the UE 145, 250 may periodically enter a sleep mode or OFF duration in which the UE 145, 250 does not monitor the PDCCH. The UE 145, 250 may periodically enter a wake mode or an ON duration in which the UE 145, 250 monitors the PDCCH to identify downlink traffic. The CDRx cycle length may identify a spacing of the wake modes, sleep modes, OFF durations, and/or ON durations. After identifying downlink traffic on the PDCCH, the UE 145, 250 may remain in wake mode to receive the downlink traffic during time windows identified by the PDCCH, as described in more detail below.

When the eNB 110, 210, 230 receives traffic to be provided to the UE 145, 250, the eNB 110, 210, 230 may buffer the traffic until a wake mode or ON duration of the UE 145, 250. The eNB 110, 210, 230 may provide information identifying the traffic to the UE 145, 250 during the wake mode or ON duration (e.g., on the PDCCH), and may thereafter provide the traffic to the UE 145, 250. The UE 145, 250 may use the CDRx cycle to determine the predicted traffic pattern, as described in more detail below.

As shown by reference number 708, the UE 145, 250 may determine that the CDRx cycle length (e.g., 20 ms) is shorter than the traffic interval (e.g., 40 ms). Accordingly, and as shown, the UE 145, 250 may determine the predicted traffic pattern according to the traffic interval of the VoLTE call. For example, when the CDRx cycle length is shorter than the traffic interval associated with the traffic type, not every CDRx wake mode or ON duration may include downlink traffic. In the scenario shown in FIG. 7A, for example, every second CDRx cycle may be expected to include scheduled traffic (e.g., based at least in part on two CDRx cycles occurring in each traffic interval). Therefore, the UE 145, 250 may use the traffic interval of 40 ms to predict time periods that include downlink traffic, as described in more detail in connection with reference numbers 710 and 712, below.

In some aspects, the CDRx cycle length may be longer than the traffic interval. In such a case, the UE 145, 250 may use the CDRx cycle length to determine the predicted traffic pattern. For example, assume that the traffic interval is 40 ms (e.g., associated with a VoLTE call) and assume that the CDRx cycle length is 60 ms. In such a case, the eNB 110, 210, 230 may receive traffic to be provided to the UE 145, 250 every 40 ms (e.g., at 40 ms, 80 ms, 120 ms, and so on). The eNB 110, 210, 230 may provide the traffic to the UE 145, 250 during ON durations of the CDRx cycle (e.g., at 60 ms, 120 ms, and so on). Therefore, the UE 145, 250 may use the CDRx cycle to determine the predicted traffic pattern (e.g., since the downlink traffic at 40 ms and 80 ms is buffered until a corresponding CDRx ON duration at 60 ms and 120 ms).

In some aspects, the CDRx cycle length and the traffic interval may be equal. In such a case, the UE 145, 250 may determine to use either or both of the CDRx cycle length and/or the traffic interval to predict the traffic pattern.

In some aspects, the UE 145, 250 may determine whether to predict a traffic pattern according to a CDRx cycle or a traffic interval based at least in part on quantities of traffic received in two or more CDRx ON durations. For example, the UE 145, 250 may determine to predict the traffic pattern according to the traffic interval when some CDRx ON durations include downlink traffic and other CDRx ON durations do not include downlink traffic, since this may indicate that the traffic interval is longer than the CDRx cycle length.

As another example, the UE 145, 250 may determine to predict the traffic pattern according to the CDRx cycle when different CDRx ON durations include different amounts of downlink traffic, since this may indicate that the CDRx cycle length is longer than the traffic interval. This may additionally or alternatively indicate that some CDRx cycles include multiple traffic bursts, whereas other CDRx cycles include a single traffic burst (e.g., as described in connection with the 60 ms CDRx cycle and the 40 ms traffic interval, above). In such a case, the UE 145, 250 may determine to predict the traffic pattern according to the CDRx cycle since the CDRx cycle may provide a more accurate representation of the traffic pattern than the traffic interval.

As yet another example, the UE 145, 250 may determine to predict the traffic pattern according to either of, or both of, the CDRx cycle length or the traffic interval when each CDRx ON duration includes an approximately equal amount of downlink traffic, since this may indicate that the CDRx cycle length aligns with the traffic interval. In this way, the UE 145, 250 determines whether to predict a traffic pattern according to a CDRx cycle length or a traffic interval based at least in part on amounts of traffic received in CDRx ON durations of the UE 145, 250, which conserves processor resources that would otherwise be used to compare lengths of the CDRx cycle and the traffic interval.

As shown by reference number 710, the UE 145, 250 may generate a Markov chain to determine the predicted traffic pattern based at least in part on the traffic type, the traffic interval, and/or the CDRx configuration (e.g., the CDRx cycle length). While aspects described herein are primarily described with reference to Markov chains, aspects described herein are not so limited. In some aspects, the UE 145, 250 may use another probabilistic model or stochastic model, such as a Monte Carlo sampling process, a particle filtering process, a Gibbs sampling process, and/or the like.

The Markov chain may include a plurality of nodes or events corresponding to a plurality of time windows. Each node or event may be associated with two or more states. A state of a node or event may indicate whether traffic is predicted to be received during a corresponding time window. For example, a node or event may be associated with a binary value, wherein a value of “1” indicates that traffic is predicted to be received and a value of “0” indicates that traffic is not predicted to be received. By using binary values, UE 145, 250 conserves processor and storage resources that would otherwise be used to implement a more complex value for the Markov chain. In some aspects, a node or event may be associated with a non-binary value. For example, the value may indicate a quantity of traffic that is expected to be received during a corresponding time window. By using non-binary values, UE 145, 250 improves accuracy of predicting traffic patterns.

The Markov chain may be associated with a prediction function that UE 145, 250 may use to determine states of the nodes. The prediction function may receive, as input, information identifying the traffic pattern and/or CDRx configuration and may output information identifying a transition probability of each link, node, or event of the Markov chain. For example, the prediction function may output information identifying a transition path of the Markov chain that is associated with a highest probability of occurrence. The transition path may identify a most likely state of each node or event. For example, assume that a first time period corresponding to a first node or event is likely to include traffic, a second time period corresponding to a second node or event is not likely to include traffic, and a third time period corresponding to a third node or event is likely to include traffic. In such a case, each node or event may be associated with a first state indicating inclusion of traffic and a second state indicating non-inclusion of traffic. The prediction function may output information identifying a transition path from a first state of the first node or event to a second state of the second node or event to a first state of the third node. The UE 145, 250 may determine the predicted traffic pattern according to the transition path.

In some aspects, the prediction function may receive device information as input. For example, the device information may include motion information that indicates whether the UE 145, 250 is stationary. When the UE 145, 250 is stationary, channel conditions may be more stable than when the UE 145, 250 is moving. Therefore, historical scheduling information, traffic patterns, and/or the like may be more accurate for stationary UEs 145, 250 than for moving UEs 145, 250. In some aspects, the prediction function may increase a confidence or probability of a transition path that is associated with a highest probability of occurrence when the UE 145, 250 is stationary.

As another example, the device information may identify variability of a CQI report of the UE 145, 250. When the CQI report is associated with a low variability, channel conditions may be more stable than when the CQI report is associated with a high variability. Therefore, historical scheduling information, traffic patterns, and/or the like may be more accurate for UEs 145, 250 with low variability of CQI reports than for UEs 145, 250 with high variability of CQI reports. In some aspects, the prediction function may increase a confidence or probability of a transition path that is associated with a highest probability of occurrence when the UE 145, 250 is associated with a low variability of CQI reports.

As another example, the device information may include display information identifying a display status of the UE 145, 250. For example, when the display of the UE 145, 250 is off, then outgoing traffic may be associated with a lower priority level or a lower likelihood of occurrence than when the display of the UE 145, 250 is on. Therefore, the UE 145, 250 may bias the prediction function toward a lower probability of reception or transmission of traffic when the display is off than when the display is on. In some aspects, the UE 145, 250 may determine the transition path based at least in part on a combination of two or more of the above types of device information.

In some aspects, the prediction function may receive, as input, information identifying historical scheduling information of the UE 145, 250, and may identify a transition path associated with a highest probability of occurrence based at least in part on the information identifying the historical transition path. For example, the UE 145, 250 may increase a probability of occurrence of a particular state of a node based at least in part on determining that the same state occurred on a corresponding node according to the historical scheduling information.

In some aspects, the prediction function may be defined as follows:

a[n]=f(A[n−1],I),

where a[n] identifies a probability of traffic being scheduled on a time window n, A[n−1]={a[n−1], a[n−2], . . . , a[n−k]} and defines a state of traffic scheduling in the previous k time windows, I identifies the device information, and f( . . . ) is a weighted function that outputs the prediction based at least in part on the information identified above.

As shown by reference number 712, the UE 145, 250 may determine the predicted path of the Markov chain to determine the predicted traffic pattern. For example, the UE 145, 250 may use the prediction function described above to determine the predicted path. In some aspects, the UE 145, 250 may use a Viterbi algorithm or a similar algorithm to determine the predicted path and/or the predicted traffic pattern. In this way, the UE 145, 250 determines a predicted traffic pattern using a probabilistic model based at least in part on a traffic type, a CDRx configuration, device information, and/or historical scheduling information associated with the UE 145, 250. The UE 145, 250 may configure one or more features of the UE 145, 250 according to the predicted traffic pattern, as described in more detail in connection with FIG. 7B, below.

As shown in FIG. 7B, and by reference number 714, the UE 145, 250 may configure features of the UE 145, 250 based at least in part on the predicted traffic pattern. The features may include, for example, a search and measurement feature of the UE 145, 250, an interference cancellation feature of the UE 145, 250, a CDRx configuration of the UE 145, 250, and/or the like. The configuration of each of these features is described in turn below.

As shown by reference number 716, in some aspects, the UE 145, 250 may schedule a search and measurement feature during non-reception and/or non-transmission periods of the UE 145, 250. For example, the UE 145, 250 may be associated with a search and/or measurement feature (e.g., a gapless search and/or measurement feature) that can perform multiple, different search and/or measurement operations in a particular time window. The UE 145, 250 may use the predicted traffic pattern to concatenate search and/or measurement operations in one or more non-reception and/or non-transmission time periods of the UE 145, 250, which conserves resources of the UE 145, 250 that would otherwise be used to perform wakeup and warmup operations. For example, the UE 145, 250 may schedule a set of search and/or measurement operations in one or more contiguous RBs, subframes, and/or the like that are predicted not to include traffic. In this way, the UE 145, 250 conserves processor, battery, and network resources that would otherwise be used to perform the set of search and/or measurement operations separately or in a time period that includes uplink and/or downlink traffic.

As shown by reference number 718, the UE 145, 250 may activate interference cancellation for time periods in which traffic is predicted to be received. For example, interference cancellation may be more effective in time periods that include more traffic than in time periods that include less traffic. The UE 145, 250 may configure interference cancellation to be performed in the time periods that include more traffic, and may configure interference cancellation not to be performed in the time periods that include less traffic. Thus, the UE 145, 250 improves efficiency of interference cancellation in the time periods that include more traffic, and conserves battery and processor resources that would be used to perform interference cancellation in the time periods that include less traffic.

In some aspects, the UE 145, 250 may select time periods in which to perform interference cancellation based at least in part on an amount of traffic predicted to be received in a particular time period. For example, each time window may be associated with a binary value that indicates whether each time window is expected to include traffic. In such a case, the UE 145, 250 may schedule interference cancellation to be performed in time windows that are predicted to include traffic, and may not schedule interference cancellation to be performed in time windows that are not expected to include traffic. Additionally, or alternatively, each time window may be associated with a non-binary value that indicates an amount of traffic that is predicted to be received in each time window. In such a case, the UE 145, 250 may schedule interference cancellation for time windows that satisfy a threshold with regard to the non-binary value. For example, the UE 145, 250 may schedule interference cancellation to be performed in time windows that are predicted to include a threshold amount of traffic.

As shown by reference number 720, in some aspects, the UE 145, 250 may skip ON durations (e.g., wake cycles) of the CDRx cycle of the UE 145, 250 during non-reception time windows. For example, the CDRx cycle of the UE 145, 250 may identify one or more ON durations during which the UE 145, 250 is to check for downlink traffic. When the UE 145, 250 determines that no downlink traffic is predicted to arrive during a particular ON duration, the UE 145, 250 may not check for downlink traffic, which conserves processor and battery resources of the UE 145, 250 that would otherwise be used to enter the ON duration and check for the downlink traffic.

As shown, in some aspects, the UE 145, 250 may provide configuration information to the eNB 110, 210, 230. The configuration information may identify configuration of the features of the UE 145, 250. For example, the configuration information may identify search and measurement times of the UE 145, 250, an interference cancellation configuration of the UE 145, 250, one or more ON durations of the CDRx cycle that the UE 145, 250 may skip, and/or the like. In some aspects, the eNB 110, 210, 230 may provide traffic and/or may perform another action based at least in part on the configuration information. For example, the eNB 110, 210, 230 may buffer network traffic during the one or more ON durations that the UE 145, 250 may skip. Additionally, or alternatively, the eNB 110, 210, 230 may broadcast a search or measurement signal during a time at which the UE 145, 250 is to perform the search and/or measurement operations.

Although implementations, described herein, include UE 145, 250 performing functions, such as predicting a traffic pattern, selectively configuring activation of one or more features, and/or the like, implementations, described herein, may be performed by a component of UE 145, 250, such as a modem processor, an application processor, or another similar component, such as additional circuitry, low power circuitry, and/or the like.

As indicated above, FIGS. 7A and 7B are provided as examples. Other examples are possible and may differ from what was described with respect to FIGS. 7A and 7B.

FIG. 8 is a diagram illustrating an example process 800 performed, for example, by a wireless communication device, in accordance with various aspects of the present disclosure. Example process 800 is an example where a wireless communication device, such as a UE (e.g., UE 145, 250), predicts traffic to configure wireless communication device features.

As shown in FIG. 8, in some aspects, process 800 may include predicting a traffic pattern, as a predicted traffic pattern, for one or more time intervals of a user equipment, wherein the predicted traffic pattern is predicted based at least in part on a traffic type of traffic transmitted or received by the user equipment and a CDRx configuration of the user equipment (block 810). For example, the UE may predict a traffic pattern, as a predicted traffic pattern, for one or more time intervals of the UE.

The one or more time intervals may include, for example, slots, subframes, frames, another type of wireless communication structure, or any combination of two or more of the above. The UE may predict the predicted traffic pattern based at least in part on a traffic type of traffic transmitted or received by the UE and a CDRx configuration of the UE. For example, the UE may use the traffic type to identify a traffic interval, and may determine the predicted traffic pattern based at least in part on the traffic interval and the CDRx configuration (e.g., based at least in part on a statistical or probabilistic model, such as a Markov chain).

As shown in FIG. 8, in some aspects, process 800 may include selectively configuring activation or deactivation of one or more features of the user equipment according to the predicted traffic pattern (block 820). For example, the UE may selectively configure activation or deactivation of one or more features of the UE. The one or more features may include, for example, an interference cancellation feature, a search and measurement feature (e.g., a gapless search and measurement feature and/or the like), a CDRx cycle feature, and/or the like. The UE may selectively configure the one or more features according to the predicted traffic pattern. For example, the UE may selectively activate, deactivate, or perform a feature in a particular time window based at least in part on a prediction of whether and/or how much traffic will be transmitted or received in the particular time window.

In some aspects, the UE, when selectively configuring activation or deactivation of the one or more features of the UE, may configure interference cancellation of the UE to be activated during a time interval, of the one or more time intervals, during which the UE is predicted to receive traffic.

In some aspects, the UE, when predicting the traffic pattern, may predict the predicted traffic pattern based at least in part on a Markov chain, wherein events of the Markov chain correspond to the one or more time intervals, and wherein states of the events identify traffic reception states on the one or more time intervals.

In some aspects, the UE, when predicting the traffic pattern, may predict the traffic pattern based at least in part one or more of motion information indicating a motion state of the UE, variation in channel quality information (CQI) of the UE, a display state of the UE, or a relationship between uplink traffic and subsequent reception of downlink traffic.

In some aspects, a particular interval may occur between receptions or transmissions of the traffic of the traffic type. The UE may predict the traffic pattern based at least in part on whether a length of the particular interval is longer than, shorter than, or equal to a CDRx cycle length of the UE, wherein the predicted traffic pattern is determined using the particular interval when the particular interval is longer than the CDRx cycle length, and wherein the predicted traffic pattern is determined using the CDRx cycle length when the particular interval is shorter than or equal to the CDRx cycle length.

In some aspects, the UE, when selectively configuring activation or deactivation of the one or more features, may configure a length of a sleep duration, of one or more components of the UE, to include a time interval, of the one or more time intervals, during which the UE is predicted to not receive traffic. Additionally, or alternatively, the UE, when selectively configuring activation or deactivation of the one or more features, may configure one or more components, of the UE, to skip a wake period for a time interval, of the one or more time intervals, during which the UE is predicted to not receive traffic. Additionally, or alternatively, the UE, when selectively configuring activation or deactivation of the one or more features, may configure a search or measurement feature of the UE to be performed in a time interval, of the one or more time intervals, during which the UE is predicted to not receive traffic.

Although FIG. 8 shows example blocks of process 800, in some aspects, process 800 may include additional blocks, fewer blocks, different blocks, or differently arranged blocks than those depicted in FIG. 8. Additionally, or alternatively, two or more of the blocks of process 800 may be performed in parallel.

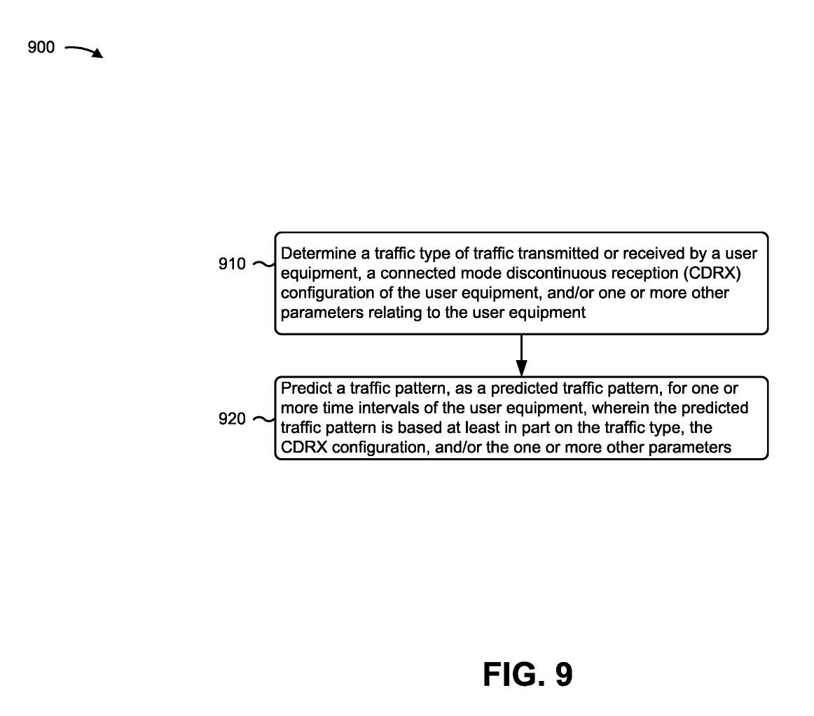

FIG. 9 is a flow chart of an example process 900 performed, for example, by a wireless communication device, in accordance with various aspects of the present disclosure. In some aspects, block 810 of FIG. 8 may include process 900 of FIG. 9. Example process 900 may be performed by a UE (e.g., the UE 145, 250).

As shown in FIG. 9, in some aspects, process 900 may include determining a traffic type of traffic transmitted or received by a user equipment, a connected mode discontinuous reception (CDRX) configuration of the user equipment, and/or one or more other parameters relating to the user equipment (block 910), and predicting a traffic pattern, as a predicted traffic pattern, for one or more time intervals of the user equipment, wherein the predicted traffic pattern is based at least in part on the traffic type, the CDRX configuration, and/or the one or more other parameters (block 920). For example, the UE 145, 250 may determine a traffic type of traffic transmitted or received by the UE 145, 250. In some aspects, the UE 145, 250 may determine the traffic type based at least in part on attributes of the traffic (e.g., a source or destination of the traffic, a header of the traffic, and/or the like). In some aspects, the UE 145, 250 may determine the traffic type based at least in part on an application that generates or receives the traffic. For example, if the application is a VoLTE calling application, the UE 145, 250 may accordingly determine a VoLTE traffic type for traffic generated or received by the application.

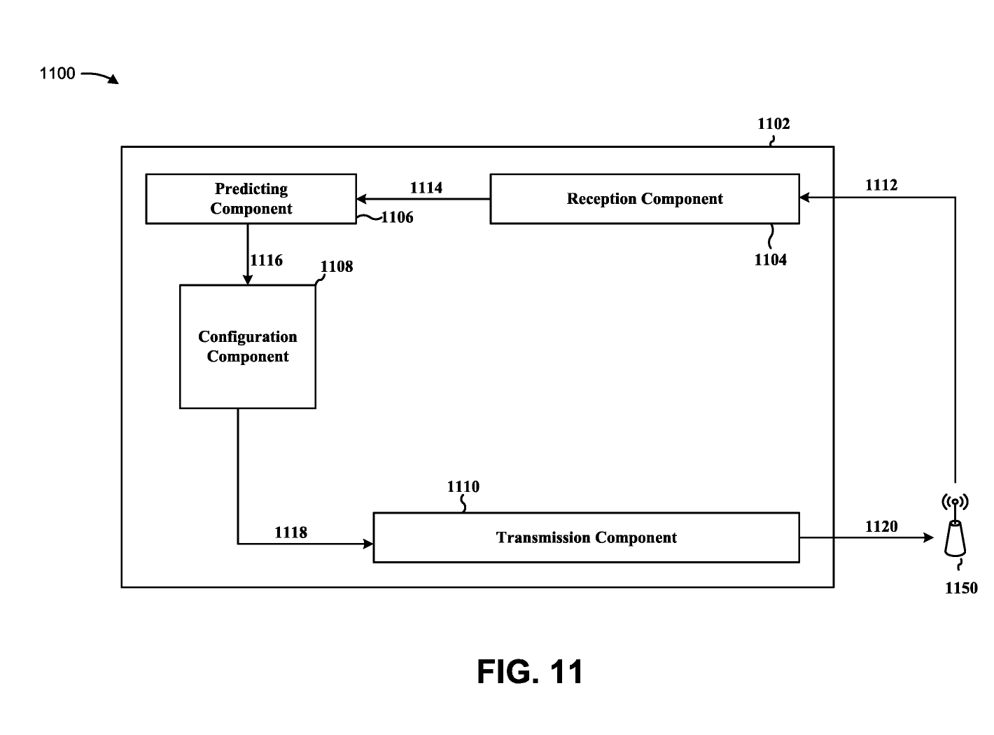

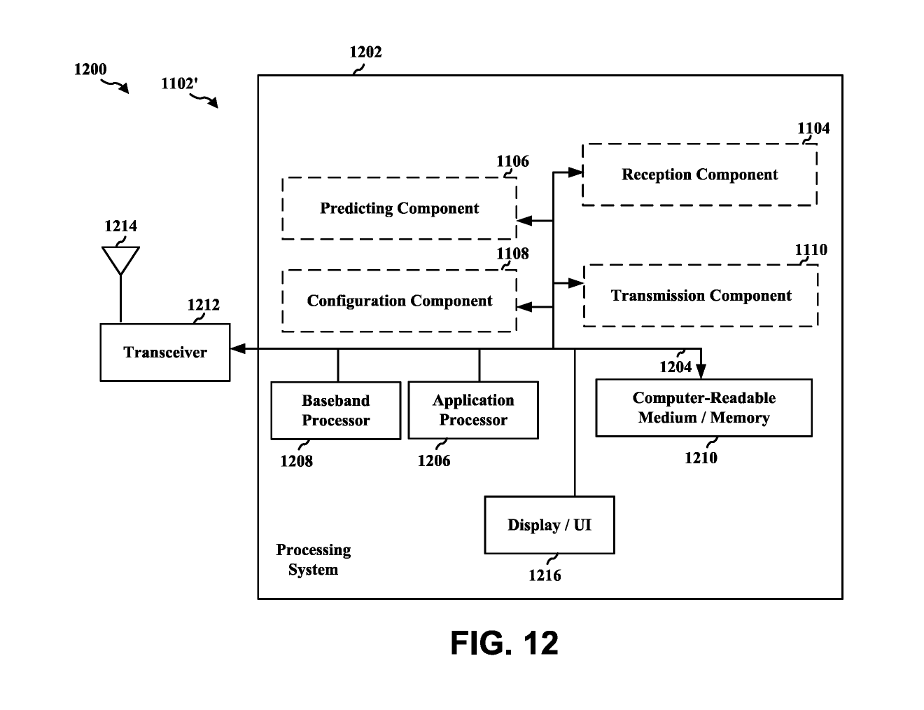

In some aspects, a processor of UE 145, 250 may determine the traffic type and predict the traffic pattern (e.g., the controller/processor 605, the TX processor 610, the RX processor 630, the application processor 1206 and/or the baseband processor 1208 of processing system 1202, and/or the like), as described in more detail in connection with FIGS. 11 and 12. In some aspects, the processor of UE 145, 250 may receive information from one or more other components of the UE 145, 250 for use to determine the traffic type and/or predict the traffic pattern (e.g., display/UE 1216, transceiver 1212, computer-readable medium/memory 1210, and/or the like). In some aspects, a predicting component 1106 of the UE 145, 250 may determine the traffic type and/or predict the traffic pattern, as described in more detail in connection with FIG. 11.

Each traffic type may be associated with one or more traffic patterns. A traffic pattern may identify predicted, observed, or configured occurrences of uplink or downlink traffic in temporal relation to each other. For example, in a VoLTE call, the UE 145, 250 may receive a packet every 40 ms. Therefore, VoLTE may be associated with a traffic pattern identifying a downlink communication every 40 ms. The UE 145, 250 may determine a predicted traffic pattern based at least in part on the traffic pattern associated with the traffic type, as described in more detail below.

In some aspects, the CDRx configuration may identify a CDRx cycle length of the UE 145, 250 (e.g., wake periods, sleep periods, ON durations, and/or the like). The UE 145, 250 may determine a predicted traffic pattern based at least in part on the CDRx cycle length based at least in part on whether and/or how the CDRx cycle length aligns with the traffic type and/or based at least in part on one or more other parameters, as described in more detail below.

In some aspects, the UE 145, 250 may determine one or more other parameters, other than the CDRx configuration and the traffic type, for determining the predicted traffic pattern. The one or more other parameters may include, for example, device information. The device information may include motion information (e.g., information indicating that the UE 145, 250 is stationary or moving at a threshold speed), information identifying variability of a CQI report (e.g., information indicating whether a change in values of a CQI report of the UE 145, 250 satisfies a threshold), display information (e.g., information indicating whether a display of the UE 145, 250, such as display 1214, is powered on or off), and/or the like. In some aspects, the one or more other parameters may include historical scheduling information identifying a relationship between an uplink transmission and a subsequent downlink transmission (e.g., once an uplink transmission is initiated, a downlink transmission may be expected to follow). The UE 145, 250 may determine a predicted traffic pattern based at least in part on the traffic type, the CDRx configuration, and/or the one or more other parameters.

To determine the predicted pattern, the UE 145, 250 may use a function that receives input including the CDRx configuration, the traffic type, and/or the one or more other parameters. For example, the function may include the prediction function described in connection with reference number 710 of FIG. 7, above. The UE 145, 250 may use the function to determine a transition path of a Markov chain to determine the predicted traffic pattern. For example, each node of the Markov chain may correspond to a respective traffic state (e.g., whether and/or how much traffic is received or transmitted), and the UE 145, 250 may determine a path with regard to each node of the Markov chain based at least in part on probabilities identified by the prediction function. In some aspects, the UE 145, 250 may determine the path based at least in part on a Viterbi algorithm or a similar algorithm. The UE 145, 250 may use the predicted traffic pattern to activate or deactivate one or more features of the UE 145, 250, as described in more detail elsewhere herein.

Although FIG. 9 shows example blocks of process 900, in some aspects, process 900 may include additional blocks, fewer blocks, different blocks, or differently arranged blocks than those depicted in FIG. 9. Additionally, or alternatively, two or more of the blocks of process 900 may be performed in parallel.

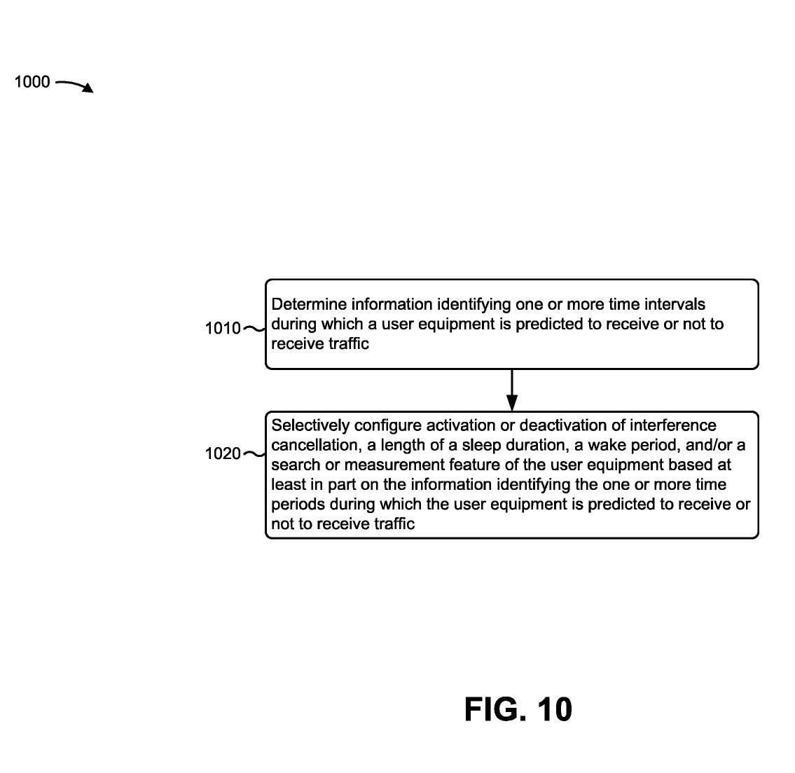

FIG. 10 is a flow chart of an example process 1000 performed, for example, by a wireless communication device, in accordance with various aspects of the present disclosure. In some aspects, block 820 of FIG. 8 may include process 1000 of FIG. 10. Example process 1000 may be performed by a UE (e.g., the UE 145, 250).

As shown in FIG. 10, in some aspects, process 1000 may include determining information identifying one or more time intervals during which a user equipment is predicted to receive or not to receive traffic (block 1010), and selectively configuring activation or deactivation of interference cancellation, a length of a sleep duration, a wake period, and/or a search or measurement feature of the user equipment based at least in part on the information identifying the one or more time periods during which the user equipment is predicted to receive or not receive traffic (block 1020). For example, the UE 145, 250 may receive or determine information identifying one or more time intervals during which the UE 145, 250 is predicted to receive or not to receive traffic, as is described in more detail in connection with FIGS. 7A, 8, and 9, above. In some aspects, the UE 145, 250 may receive or determine information identifying one or more time intervals during which the UE 145, 250 is predicted to transmit or not to transmit traffic. The one or more time intervals may include, for example, frames, subframes, slots, groups of multiple frames, subframes, or slots, and/or the like.

In some aspects, a processor of UE 145, 250 may determine the information identifying the one or more time intervals and/or selectively configure activation or deactivation of one or more features of the UE 145, 250 (e.g., the controller/processor 605, the TX processor 610, the RX processor 630, the application processor 1206 and/or the baseband processor 1208 of processing system 1202, and/or the like), as described in more detail in connection with FIGS. 11 and 12. For example, a predicting component 1106 of the UE 145, 250 may determine the information identifying the one or more time intervals, and a configuration component 1108 of the UE 145, 250 may selectively configure activation or deactivation of the one or more features.

In some aspects, the UE 145, 250 may selectively configure activation or deactivation of interference cancellation based at least in part on the information identifying the one or more time periods during which the UE 145, 250 is predicted to receive or not to receive traffic. For example, the UE 145, 250 may configure interference cancellation to be activated during one or more time periods during which the UE 145, 250 is predicted to receive traffic (e.g., a threshold amount of traffic) and/or may configure interference cancellation to be deactivated during one or more time periods during which the UE 145, 250 is predicted not to receive traffic.

In some aspects, the UE 145, 250 may selectively configure a length of a sleep duration based at least in part on the information identifying the one or more time periods during which the UE 145, 250 is predicted to receive or not to receive traffic. The sleep duration may be associated with a CDRx cycle of the UE 145, 250. For example, the UE 145, 250 may configure the UE 145, 250 to sleep during one or more time periods based at least in part on determining that traffic is not likely to be received in the one or more time periods.

In some aspects, the UE 145, 250 may selectively configure a wake period for the UE 145, 250 based at least in part on the information identifying the one or more time periods during which the UE 145, 250 is predicted to receive or not to receive traffic. For example, the UE 145, 250 may schedule a wake period to cause the UE 145, 250 to receive traffic in one or more time periods during which the UE 145, 250 is predicted to receive traffic.

In some aspects, the UE 145, 250 may selectively configure a search or measurement feature based at least in part on the information identifying the one or more time periods during which the UE 145, 250 is predicted to receive or not to receive traffic. For example, the UE 145, 250 may perform gapless search and measurement to concatenate multiple, different search and measurement operations during idle periods (e.g., no downlink or uplink traffic) of the UE 145, 250. The UE 145, 250 may use the predicted traffic pattern to identify time periods in which no traffic is predicted to be transmitted or received, and may schedule search and measurement operations in the time periods.

Although FIG. 10 shows example blocks of process 1000, in some aspects, process 1000 may include additional blocks, fewer blocks, different blocks, or differently arranged blocks than those depicted in FIG. 10. Additionally, or alternatively, two or more of the blocks of process 1000 may be performed in parallel.

FIG. 11 is a conceptual data flow diagram 1100 illustrating the data flow between different modules/means/components in an example apparatus 1102. The apparatus 1102 may be a UE 145, 250. In some aspects, the apparatus 1102 includes a reception component 1104, a predicting component 1106, a configuration component 1108, and/or a transmission component 1110. In some aspects, components 1104 through 1110 and/or other components may be software components, hardware components, a combination of software components and firmware components, and/or the like. For example, a UE may implement components 1104 through 1110 and/or other components as software components of a processing system, such as a baseband processor 1208 of the UE 145, 250, an application processor 1206 of the UE 145, 250, an RX processor 650 of UE 145, 250, a TX processor 680 of UE 145, 250, a controller/processor 660 of UE 145, 250, and/or the like. Additionally, or alternatively, components 1104 through 1110 may be implemented in other ways than as described herein.

The reception component 1104 may receive data 1112 from a base station 1150 (e.g., the eNB 110, 210, 230, and/or the like). The data 1112 may include traffic, scheduling information, and/or the like. The reception component 1104 may provide the data 1112, as data 1114, to the predicting component 1106. The predicting component 1108 may provide data 1116 to the transmission component 1110. The data 1116 may include information identifying a predicted traffic pattern for one or more time intervals of the apparatus 1102. For example, the predicted traffic pattern may include information identifying whether and/or how much traffic is predicted to be received on the one or more time intervals.

The configuration component 1108 may provide data 1118 to the transmission component 1110. The data 1118 may include information identifying and/or relating to one or more features that are configured by the configuration component 1108 based at least in part on the predicted traffic pattern, such as configuration information that identifies a configuration of the one or more features. Additionally, or alternatively, the data 1118 may include traffic to be transmitted by the transmission component 1110 to the base station 1150. The transmission component 1110 may transmit data 1120 to the base station 1150. The data 1120 may include uplink traffic, configuration information for the apparatus 1102 and/or the one or more features, and/or the like. In some aspects, the transmission component may provide the data 1120 to a transceiver (e.g., transceiver Tx/Rx 645, transceiver 1212, and/or the like) which may generate a signal based at least in part on the data 1120 to be transmitted by an antenna of the apparatus. Such a transceiver may be included in the transmission component, or may be separate from the transmission component, as described in connection with FIG. 12, below.

The apparatus may include additional components that perform each of the blocks of the algorithm in the aforementioned flow chart of FIGS. 8, 9, and/or 10. As such, each block in the aforementioned flow chart of FIGS. 8, 9, and/or 10 may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

The number and arrangement of components shown in FIG. 11 are provided as an example. In practice, there may be additional components, fewer components, different components, or differently arranged components than those shown in FIG. 11. Furthermore, two or more components shown in FIG. 11 may be implemented within a single component, or a single component shown in FIG. 11 may be implemented as multiple, distributed components. Additionally, or alternatively, a set of components (e.g., one or more components) shown in FIG. 11 may perform one or more functions described as being performed by another set of components shown in FIG. 11.

FIG. 12 is a diagram 1200 illustrating an example of a hardware implementation for an apparatus 1102′ employing a processing system 1202. The apparatus 1102′ may be a UE 145, 250. In other words, FIG. 12 illustrates example hardware that may be capable of implementing the components and modules 1104, 1106, 1108, and 1110 described in connection with FIG. 11, above.

The processing system 1202 may be implemented with a bus architecture, represented generally by the bus 1204. The bus 1204 may include any number of interconnecting buses and bridges depending on the specific application of the processing system 1202 and the overall design constraints. The bus 1204 links together various circuits including one or more processors and/or hardware components, represented by the processors 1206 and 1208, the components 1104, 1106, 1108, 1110, and the computer-readable medium/memory 1210. The bus 1204 may also link various other circuits such as timing sources, peripherals, voltage regulators, and power management circuits, which are well known in the art, and therefore, will not be described any further. In some aspects, the apparatus 1102′ includes a display 1216. The display 1216 may be used to display a user interface. One or more components of apparatus 1102′ may be housed within a housing.

Dashed lines of components 1104, 1106, 1108, and 1110 indicate that the components 1104, 1106, 1108, and 1110 are provided for illustration but may be implemented as software or firmware modules of, for example, application processor 1206 and/or baseband processor 1208. Additionally, or alternatively, additional modules, fewer modules, or a different combination of modules may be implemented as software or firmware modules of, for example, application processor 1206 and/or baseband processor 1208.

The processing system 1202 may be coupled to a transceiver 1212. The transceiver 1212 is coupled to one or more antennas 1214. The transceiver 1212 provides a means for communicating with various other apparatus over a transmission medium. The transceiver 1212 receives a signal from the one or more antennas 1214, extracts information from the received signal, and provides the extracted information to the processing system 1202, specifically the reception component 1104. In addition, the transceiver 1212 receives information from the processing system 1202, specifically the transmission component 1110, and based at least in part on the received information, generates a signal to be applied to the one or more antennas 1214. The processing system 1202 includes an application processor 1206 and a baseband processor 1208 coupled to a computer-readable medium/memory 1210. The application processor 1206/baseband processor 1208 is responsible for general processing, including the execution of software stored on the computer-readable medium/memory 1208. The software, when executed by the application processor 1206/baseband processor 1208, causes the processing system 1202 to perform the various functions described supra for any particular apparatus. The computer-readable medium/memory 1210 may also be used for storing data that is manipulated by the application processor 1206/baseband processor 1208 when executing software. The processing system further includes at least one of the components 1104, 1106, 1108, 1110. The components may be software components running in the application processor 1206, resident/stored in the computer readable medium/memory 1210, one or more hardware components coupled to the application processor 1206/baseband processor 1208, or some combination thereof. The processing system 1202 may be a component of the UE 145, 250 and may include the memory 665 and/or at least one of the TX processor 680, the RX processor 650, and/or the controller/processor 660. The application processor 1206 may run an operating system and/or applications software of the apparatus. The baseband processor 1208 may handle digital processing relating to radio communication of the apparatus.

In some aspects, the apparatus 1102/1102′ for wireless communication includes means for predicting a traffic pattern, as a predicted traffic pattern, for one or more time intervals of a user equipment, wherein the predicted traffic pattern is predicted based at least in part on a traffic type of traffic transmitted or received by the user equipment and a connected mode discontinuous reception (CDRx) configuration of the user equipment; means for selectively configuring activation or deactivation of one or more features of the user equipment according to the predicted traffic pattern; means for configuring interference cancellation of the user equipment to be activated during a time interval, of the one or more time intervals, during which the user equipment is predicted to receive traffic; means for predicting the predicted traffic pattern based at least in part on a Markov chain, wherein events of the Markov chain correspond to the one or more time intervals, and wherein states of the events identify traffic reception states on the one or more time intervals; means for predicting the traffic pattern based at least in part on one or more of motion information indicating a motion state of the user equipment, variation in channel quality information (CQI) of the user equipment, a display state of the user equipment, or a relationship between uplink traffic and subsequent reception of downlink traffic; means for predicting the traffic pattern based at least in part on whether a length of a particular interval is longer than, shorter than, or equal to a CDRx cycle length of the user equipment, wherein the predicted traffic pattern is determined using the particular interval when the particular interval is longer than the CDRx cycle length, and wherein the predicted traffic pattern is determined using the CDRx cycle length when the particular interval is shorter than or equal to the CDRx cycle length; means for configuring a length of a sleep duration, of one or more components of the user equipment, to include a time interval, of the one or more time intervals, during which the user equipment is predicted to not receive traffic; causing one or more components, of the user equipment, to skip a wake period for a time interval, of the one or more time intervals, during which the user equipment is predicted to not receive traffic; and means for configuring a search or measurement feature of the user equipment to be performed in a time interval, of the one or more time intervals, during which the user equipment is predicted to not receive traffic. The aforementioned means may be one or more of the aforementioned components of the apparatus 1102 and/or the processing system 1202 of the apparatus 1102′ configured to perform the functions recited by the aforementioned means. As described supra, the processing system 1202 may include the RX processor 650, the controller/processor 660, and/or the TX processor 680. As such, in one configuration, the aforementioned means may be the RX processor 650, the controller/processor 660, and/or the TX processor 680, configured to perform the functions recited by the aforementioned means.

In some aspects, application processor 1206 and/or baseband processor 1208 may include an intelligent hardware device, (e.g., a general-purpose processor, a DSP, a CPU, a microcontroller, an ASIC, an FPGA, a programmable logic device, a discrete gate or transistor logic component, a discrete hardware component, a system on chip (SOC) processor, or any combination thereof). In some aspects, application processor 1206 and/or baseband processor 1208 may be configured to operate a memory array using a memory controller. In other cases, a memory controller may be integrated into application processor 1206 and/or baseband processor 1208. Application processor 1206 and/or baseband processor 1208 may be configured to execute computer-readable instructions stored in a memory to perform various functions (e.g., functions or tasks supporting predicting traffic to configure user equipment features).

FIG. 12 is provided as an example. Other examples are possible and may differ from what was described in connection with FIG. 12.

The foregoing disclosure provides illustration and description, but is not intended to be exhaustive or to limit the aspects to the precise form disclosed. Modifications and variations are possible in light of the above disclosure or may be acquired from practice of the aspects.

As used herein, the term component is intended to be broadly construed as hardware, firmware, or a combination of hardware and software. As used herein, a processor is implemented in hardware, firmware, or a combination of hardware and software.

Some aspects are described herein in connection with thresholds. As used herein, satisfying a threshold may refer to a value being greater than the threshold, greater than or equal to the threshold, less than the threshold, less than or equal to the threshold, equal to the threshold, not equal to the threshold, and/or the like.

It will be apparent that systems and/or methods, described herein, may be implemented in different forms of hardware, firmware, or a combination of hardware and software. The actual specialized control hardware or software code used to implement these systems and/or methods is not limiting of the aspects. Thus, the operation and behavior of the systems and/or methods were described herein without reference to specific software code—it being understood that software and hardware can be designed to implement the systems and/or methods based, at least in part, on the description herein.

Even though particular combinations of features are recited in the claims and/or disclosed in the specification, these combinations are not intended to limit the disclosure of possible aspects. In fact, many of these features may be combined in ways not specifically recited in the claims and/or disclosed in the specification. Although each dependent claim listed below may directly depend on only one claim, the disclosure of possible aspects includes each dependent claim in combination with every other claim in the claim set. A phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

No element, act, or instruction used herein should be construed as critical or essential unless explicitly described as such. Also, as used herein, the articles “a” and “an” are intended to include one or more items, and may be used interchangeably with “one or more.” Furthermore, as used herein, the terms “set” and “group” are intended to include one or more items (e.g., related items, unrelated items, a combination of related and unrelated items, and/or the like), and may be used interchangeably with “one or more.” Where only one item is intended, the term “one” or similar language is used. Also, as used herein, the terms “has,” “have,” “having,” and/or the like are intended to be open-ended terms. Further, the phrase “based on” is intended to mean “based, at least in part, on” unless explicitly stated otherwise.

What is claimed is:

1. A method of wireless communication, comprising:
predicting a traffic pattern, as a predicted traffic pattern, for one or more time intervals of a user equipment,
wherein the predicted traffic pattern is predicted based at least in part on a traffic type of traffic transmitted or received by the user equipment and a connected mode discontinuous reception (CDRx) configuration of the user equipment; and
selectively configuring activation or deactivation of one or more features of the user equipment according to the predicted traffic pattern.

2. The method of claim 1, wherein selectively configuring activation or deactivation of the one or more features of the user equipment comprises:
configuring interference cancellation of the user equipment to be activated during a time interval, of the one or more time intervals, during which the user equipment is predicted to receive traffic.

3. The method of claim 1, wherein predicting the traffic pattern comprises:
predicting the predicted traffic pattern based at least in part on a Markov chain,
wherein events of the Markov chain correspond to the one or more time intervals, and
wherein states of the events identify traffic reception states on the one or more time intervals.

4. The method of claim 1, wherein predicting the traffic pattern comprises:
predicting the traffic pattern based at least in part on one or more of:
motion information indicating a motion state of the user equipment,
variation in channel quality information (CQI) of the user equipment,
a display state of the user equipment, or
a relationship between uplink traffic and subsequent reception of downlink traffic.

5. The method of claim 1, wherein a particular interval occurs between receptions or transmissions of the traffic of the traffic type; and
wherein predicting the traffic pattern comprises:
predicting the traffic pattern based at least in part on whether a length of the particular interval is longer than, shorter than, or equal to a CDRx cycle length of the user equipment,
wherein the predicted traffic pattern is determined using the particular interval when the particular interval is longer than the CDRx cycle length, or
wherein the predicted traffic pattern is determined using the CDRx cycle length when the particular interval is shorter than or equal to the CDRx cycle length.

6. The method of claim 1, wherein selectively configuring activation or deactivation of the one or more features of the user equipment comprises:
configuring a length of a sleep duration, of one or more components of the user equipment, to include a time interval, of the one or more time intervals, during which the user equipment is predicted to not receive traffic.

7. The method of claim 1, wherein selectively configuring activation or deactivation of the one or more features of the user equipment comprises:
causing one or more components, of the user equipment, to skip a wake period for a time interval, of the one or more time intervals, during which the user equipment is predicted to not receive traffic.

8. The method of claim 1, wherein selectively configuring activation or deactivation of the one or more features of the user equipment comprises:
configuring a search or measurement feature of the user equipment to be performed in a time interval, of the one or more time intervals, during which the user equipment is predicted to not receive traffic.

9. A wireless communication device, comprising:
a memory; and
one or more processors operatively coupled to the memory, the one or more processors configured to:
predict a traffic pattern, as a predicted traffic pattern, for one or more time intervals of the wireless communication device,
wherein the predicted traffic pattern is predicted based at least in part on a traffic type of traffic transmitted or received by the wireless communication device and a connected mode discontinuous reception (CDRx) configuration of the wireless communication device; and
selectively configure activation or deactivation of one or more features of the wireless communication device according to the predicted traffic pattern.

10. The wireless communication device of claim 9, wherein the one or more processors, when selectively configuring activation or deactivation of the one or more features of the wireless communication device, are configured to:
configure interference cancellation of the wireless communication device to be activated during a time interval, of the one or more time intervals, during which the wireless communication device is predicted to receive traffic.

11. The wireless communication device of claim 9, wherein the one or more processors, when predicting the traffic pattern, are configured to:
predict the predicted traffic pattern based at least in part on a Markov chain,
wherein events of the Markov chain correspond to the one or more time intervals, and
wherein states of the events identify traffic reception states on the one or more time intervals.

12. The wireless communication device of claim 9, wherein the one or more processors, when predicting the traffic pattern, are configured to:
predict the traffic pattern based at least in part on one or more of:
motion information indicating a motion state of the wireless communication device,
variation in channel quality information (CQI) of the wireless communication device,
a display state of the wireless communication device, or
a relationship between uplink traffic and subsequent reception of downlink traffic.

13. The wireless communication device of claim 9, wherein a particular interval occurs between receptions or transmissions of the traffic of the traffic type; and
wherein the one or more processors, when predicting the traffic pattern, are configured to:
predict the traffic pattern based at least in part on whether a length of the particular interval is longer than, shorter than, or equal to a CDRx cycle length of the wireless communication device,
wherein the predicted traffic pattern is determined using the particular interval when the particular interval is longer than the CDRx cycle length, or
wherein the predicted traffic pattern is determined using the CDRx cycle length when the particular interval is shorter than or equal to the CDRx cycle length.

14. The wireless communication device of claim 9, further comprising:
a display,
a user interface,
one or more transceivers,
one or more antennas, or
some combination thereof.

15. An apparatus for wireless communication, comprising:
means for predicting a traffic pattern, as a predicted traffic pattern, for one or more time intervals of the apparatus,
wherein the predicted traffic pattern is predicted based at least in part on a traffic type of traffic transmitted or received by the apparatus and a connected mode discontinuous reception (CDRx) configuration of the apparatus; and
means for selectively configuring activation or deactivation of one or more features of the apparatus according to the predicted traffic pattern.

16. The apparatus of claim 15, wherein the means for selectively configuring activation or deactivation of the one or more features of the apparatus comprises:
means for configuring interference cancellation of the apparatus to be activated during a time interval, of the one or more time intervals, during which the apparatus is predicted to receive traffic.

17. The apparatus of claim 15, wherein the means for predicting the traffic pattern comprises:
means for predicting the traffic pattern based at least in part on one or more of:
motion information indicating a motion state of the apparatus,
variation in channel quality information (CQI) of the apparatus,
a display state of the apparatus, or
a relationship between uplink traffic and subsequent reception of downlink traffic.

18. The apparatus of claim 15, wherein a particular interval occurs between receptions or transmissions of the traffic of the traffic type; and
wherein the means for predicting the traffic pattern comprises:
means for predicting the traffic pattern based at least in part on whether a length of the particular interval is longer than, shorter than, or equal to a CDRx cycle length of the apparatus,
wherein the predicted traffic pattern is determined using the particular interval when the particular interval is longer than the CDRx cycle length, or
wherein the predicted traffic pattern is determined using the CDRx cycle length when the particular interval is shorter than or equal to the CDRx cycle length.

19. The apparatus of claim 15, wherein the means for selectively configuring activation or deactivation of the one or more features of the apparatus comprises:
means for configuring a length of a sleep duration, of one or more components of the apparatus, to include a time interval, of the one or more time intervals, during which the apparatus is predicted to not receive traffic.

20. The apparatus of claim 15, wherein the means for selectively configuring activation or deactivation of the one or more features of the apparatus comprises:
means for configuring a search or measurement feature of the apparatus to be performed in a time interval, of the one or more time intervals, during which the apparatus is predicted to not receive traffic.
